(19) United States
(12) Patent Application Publication
(10) Pub. No.: US 2014/0297367 A1
(43) Pub. Date: Oct. 2, 2014

(54) SMART DESIGN SYSTEM PROVIDING MOBILE APPLICATION DESIGN AND SIMULATION FUNCTION, BUSINESS MODEL HAVING THE SAME, AND OPERATING METHOD OF SMART DESIGN SYSTEM

(71) Applicants: Jung-woo LEE, Seoul (KR); Dong-soo JUN, Seoul (KR); Min-gyu HWANG, Suwon-si (KR); Jung-ho JUNG, Suwon-si (KR); Keun-woo KO, Suwon-si (KR)

(72) Inventors: Jung-woo LEE, Seoul (KR); Dong-soo JUN, Seoul (KR); Min-gyu HWANG, Suwon-si (KR); Jung-ho JUNG, Suwon-si (KR); Keun-woo KO, Suwon-si (KR)

(21) Appl. No.: 14/199,138

(22) Filed: Mar. 6, 2014

(30) Foreign Application Priority Data
Mar. 28, 2013 (KR) 10-2013-0033742
Apr. 9, 2013 (KR) PCT/KR2013/002964

(51) Int. Cl. G06Q 30/06; G06Q 30/02

(52) U.S. Cl. CPC G06Q 30/0621; G06Q 30/0204
USPC 705/7.33; 705/7.29

(57) ABSTRACT

A smart design system provides a mobile application design and a simulation function, a business model including the smart design system, and a method of operating the smart design system. A method of operating a smart design system includes selecting at least one product of a plurality of products by searching a database storing information related to the plurality of products. The method includes designing an application that includes the selected at least one product. The designing may be used to produce the application. The method includes providing at least one recommended product of the plurality of products. The recommended product is applicable to the application. The method includes providing a market trend analysis. The market trend analysis is generated by searching for information related to a market trend of at least one of the plurality of products applicable to the application.

### CROSS-REFERENCE TO RELATED APPLICATIONS

This application claims the benefit of Korean Patent Application No. 10-2013-0033742, filed on Mar. 28, 2013 in the Korean Intellectual Property Office, and International Application No. PCT/KR2013/002964, filed on Apr. 9, 2013 in the Korean Intellectual Property Office, both of which are incorporated herein in their entirety by reference.

### BACKGROUND

1. Field

Example embodiments relate to a smart design system, and more particularly, to a smart design system capable of providing a mobile application design and a simulation function, a business model including the smart design system, and a method of operating the smart design system.

2. Related Art

Recently, systems that enable clients to buy a desired product on-line have been increasingly developed. Clients who buy a product need to buy a most appropriate product that matches their needs. For example, when a client desires to buy a part employed in a device (e.g., a tablet personal computer, a smart phone, and/or other like a mobile devices) to be manufactured, he or she may buy a product optimized in consideration of compatibility with the device.

In particular, large quantities of the same product are highly likely to be transacted between enterprises, and serious damage may thus occur when optimized products are not provided to the client. In other words, when an enterprise that provides a product has a capability of providing to a client an optimized product that matches the client's needs, sale profits of the enterprise may be sharply increased.

However, in the case of conventional on-line transactions, products that are for sale are introduced by simply providing a list of the products and/or arbitrarily selecting and recommending some products. Thus, it is not easy to provide clients with optimum products specialized therefor. Also, in the case of some specialized industries, such as the semiconductor device industry, on-line transactions have not yet been activated and a great deal of business is done offline, thereby causing inconvenience.

### SUMMARY

Example embodiments provide a smart design system for providing a design and simulation tool of an application, to provide a result of simulating an application designed directly for individual clients so that each of the clients may buy a desired product, and a business model having the smart design system, and a method of operating the smart design system.

According to an example embodiment, a method of operating a smart design server is provided. The method includes selecting at least one product of a plurality of products by searching a database storing intonation related to the plurality of products. The method includes designing an application that includes the selected at least one product. The designing may be used to produce the application. The method includes providing at least one recommended product of the plurality of products. The recommended product is applicable to the application. The method includes providing a market trend analysis. The market trend analysis is generated by searching for information related to a market trend of at least one of the plurality of products applicable to the application.

According to an example embodiment, a smart design server is provided. The smart design server includes an application design module configured to select at least one product of a plurality of products, and design an application that includes the selected at least one product. The plurality of products are applicable to the application. The design may be used to produce the application. The smart design server includes a positioning module configured to provide a search result that includes at least one recommended product. The at least one recommended product is from among the plurality of products. The smart design server includes a trend monitoring module configured to search for information related to a market trend of the plurality of products, and provide a market trend analysis based on the search.

According to an example embodiment, a method of operating a client terminal is provided. The method includes accessing a smart design service. The method includes selecting at least one product of a plurality of products to be included in an application. The at least one product is used by the smart design service to design the application. The designing may be used to produce the application. The method includes receiving at least one recommended product. The at least one recommended product is one of the plurality of products, and the at least one recommended product is determined to be applicable to the application. The method includes receiving market trend information to be used for a market trend analysis of at least one other product of the plurality of products determined to be applicable to the application.

According to an example embodiment, a client terminal is provided. The client terminal includes an application design request unit for providing an input for selecting at least one product to be included in an application to be designed by a smart design service. The designing may be used to produce the application. The at least one product is one of a plurality of products. The client terminal includes a receiver for receiving at least one recommended product applicable to the application. The at least one recommended product being one of the plurality of products. The client terminal includes a recommended product application request unit for providing an input for selecting the at least one recommended product such that the at least one recommended product is used for designing the application.

According to an example embodiment, a positioning processor is provided. The a positioning processor includes a score and weight setting unit for setting a product weight with respect to each of at least one product of a plurality of products and a product attribute score, and for setting a product attribute weight with respect to at least one attribute defined for each of the plurality of products. The positioning processor includes an application score calculator for calculating a product score by performing an arithmetic operation on at least one selected product of the plurality of products using the product attribute score and the product attribute weight, and for calculating an application score by performing an arithmetic operation on a product score calculated for the at least one selected product and the product weight. The positioning processor includes a positioning diagrammatizing processor for processing the position of the plurality of products. The processing including diagrammatizing, and for outputting the diagrammatizing according to the application score.

According to an example embodiment, a trend monitoring processor is provided. The trend monitoring processor includes a trend target selector for selecting at least one product for trend monitoring. The trend monitoring processor includes a factor selector for selecting at least one factor from among a plurality of factors. The plurality of factors are related to attributes of the at least one product for the trend monitoring. The trend monitoring processor includes a trend diagrammatizing unit for diagrammatizing the trend monitoring, and for outputting the diagrammatized trend monitoring on a graph having at least one axis.

According to an example embodiment, a method of diagrammatizing a position of a product for designing an application by a smart server is provided. The method includes determining a position of at least one selected product from among a plurality of products, the position being relative to the application. The method includes diagrammatizing the position of the selected one of a plurality of products. The method includes providing the diagrammatized position to be used for producing the application.

According to an example embodiment, a method of monitoring a market trend of at least one of a plurality of products applicable to an application designed by a smart design system is provided. The method includes selecting at least one product to be monitored for a market trend, the selected at least one product being one of the plurality of products. The method includes diagrammatizing the monitoring of the market trend of the selected at least one product. The method includes providing the diagrammatized market to be used for designing an application, the design being used for producing the application.

### BRIEF DESCRIPTION OF THE DRAWINGS

Exemplary embodiments will be more clearly understood from the following detailed description taken in conjunction with the accompanying drawings in which:

FIG. 1 is a block diagram of a smart design system and a business model including the smart design system according to example embodiments;

FIG. 2 is a block diagram illustrating operations of the smart design system of FIG. 1 according to example embodiments;

FIG. 3 is a block diagram illustrating operations of elements of the smart design system illustrated in FIG. 2 according to example embodiments;

FIG. 4 is a block diagram of a smart design system according to example embodiments;

FIGS. 5 to 8 are block diagrams of the structures of some elements of the smart design system of FIG. 4 according to example embodiments;

FIG. 9 is a flowchart illustrating whole operations of a smart design system according to example embodiments;

FIG. 10 is a conceptual diagram illustrating an operation of selecting a product according to example embodiments;

FIG. 11 is a diagram illustrating a web page screen image providing design options according to example embodiments;

FIGS. 12A to 12C are flowcharts illustrating operations performed based on the concept of FIG. 11 according to example embodiments;

FIG. 13 is a diagram illustrating a web page screen image providing an architecture selection function according to example embodiments;

FIGS. 14A to 14G are block diagrams of architecture types that may be defined for a smart phone according to example embodiments;

FIG. 15 is a diagram illustrating a web page providing a product selection function according to example embodiments;

FIGS. 16A to 16D are flowcharts illustrating a method of selecting a product using the web page of FIG. 15 according to example embodiments;

FIG. 17 is a conceptual diagram illustrating positioning and product recommendation according to example embodiments;

FIG. 18 is a diagram illustrating a web page screen image providing a positioning analysis result according to example embodiments;

FIGS. 19 and 20 are flowcharts illustrating a positioning analysis method and a method of recommending products according to example embodiments;

FIGS. 21A to 21E are tables illustrating scores and weights assigned to a plurality of products and a method of calculating a score of an application according to example embodiments;

FIGS. 22 and 23 illustrate a result of diagrammatizing scores calculated based on results of analyzing positioning of products according to example embodiments;

FIG. 24 is a conceptual diagram illustrating trend monitoring according to example embodiments;

FIG. 25 is a flowchart illustrating the trend monitoring of FIG. 24 according to example embodiments;

FIGS. 26A, 26B, and 27 illustrate screen images output as a result of searching for a trend monitoring result according to example embodiments;

FIG. 28 is a conceptual diagram illustrating an operation of searching for detailed information regarding a product according to an example embodiments;

FIG. 29 is a conceptual diagram illustrating portfolio storing according to example embodiments;

FIGS. 30 and 31 are flowcharts illustrating a method of searching for detailed information regarding a product and a method of driving a project plan according to example embodiments;

FIG. 32 illustrates functional blocks included in a project plan tool according to example embodiments;

FIG. 33 is a detailed flowchart illustrating an operation of a project plan according to example embodiments;

FIG. 34 is a flowchart illustrating a method of operating a client system according to example embodiments; and

FIG. 35 is a block diagram of a client system according to example embodiments.

### DETAILED DESCRIPTION OF THE EMBODIMENTS

Hereinafter, example embodiments will be described in detail by explaining exemplary embodiments thereof with reference to the accompanying drawings. Like reference numerals denote like elements throughout the drawings. Example embodiments may be embodied in many different forms and should not be construed as limited to the exemplary embodiments set forth herein. Rather, these embodiments are provided so that this disclosure will be thorough and complete, and will fully convey the scope to those skilled in the art.

As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms ‘first’, ‘second’, ‘third’, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings. For example, a first element may be designated as a second element, and similarly, a second element may be designated as a first element without departing from the teachings.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

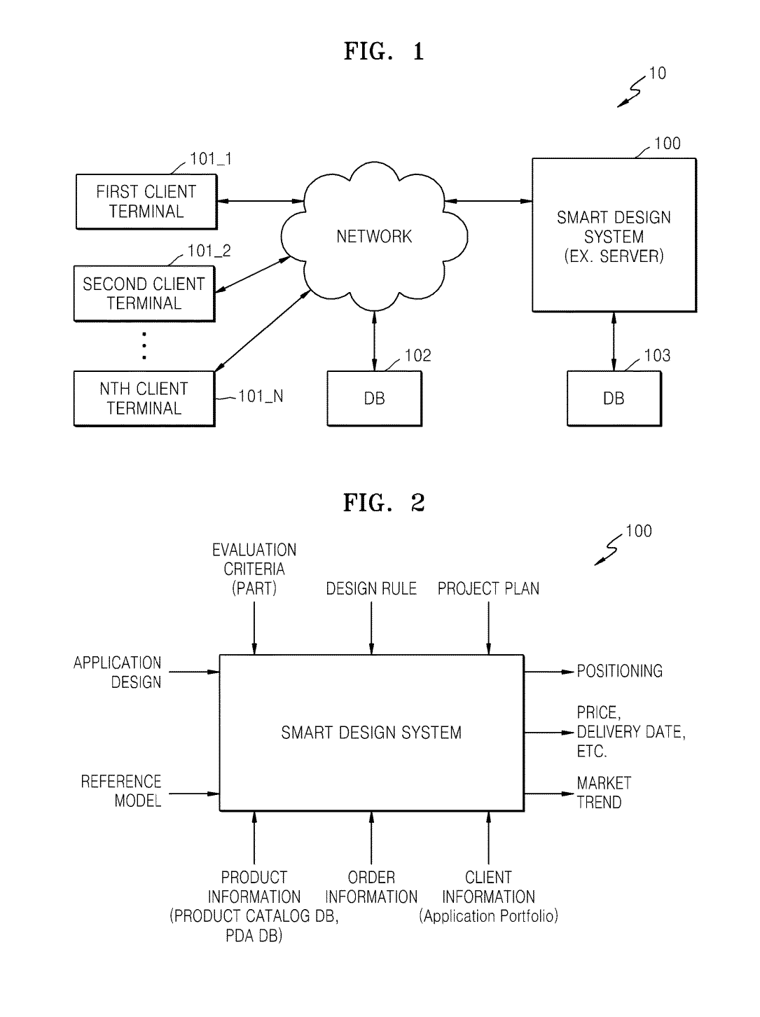

FIG. 1 is a block diagram of a smart design system 100 and a business model 10 including the smart design system 100 according to example embodiments.

As illustrated in FIG. 1, the business model 10 according to example embodiments includes the smart design system 100. The smart design system 100 may communicate with at least one client system via a network. The at least one client system is a device capable of establishing communication via the network and may be referred to as client terminals 101_1 to 101_N (wherein N is an integer greater than or equal to one (1)). The smart design system 100 may be referred to as an apparatus configured to provide a smart design service to the client by communicating with the client terminals 101_1 to 101_N. For example, the smart design system 100 may be embodied as a server and/or any other like network device capable of searching for and selling a product on-line. Smart design system 100 may be configured to establish, manage, and terminate communications sessions, for example between smart design system 100 and client terminals 101_1 to 101_N. Smart design system 100 may also be configured to establish, manage, and terminate communications sessions between two or more client terminals. To this end, smart design system 100 may be configured to receive/send communication requests from/to client devices. Clients who use the client terminals 101_1 to 101_N may access the smart design system 100 and be provided a smart design service using a web page that the smart design system 100 provides, via the network. Although FIG. 1 illustrates that the business model 10 is configured to include the smart design system 100, a business model concept may be defined as a concept of an operation performed among the smart design system 100, the client terminals 101_1 to 101_N, and one or more databases.

According to various embodiments, client terminals 101_1 to 101_N may be a hardware computing devices capable of communicating with a server or other like network element (e.g., smart design system 100), such that client terminals 101_1 to 101_N is able to receive services from the server. Client terminals 101_1 to 101_N may include memory, one or more processors, and (optionally) transceiver. Client terminals 101_1 to 101_N may be configured to send/receive data to/from network devices, such as a router, switch, or other like network devices, via a wired or wireless connection. Client terminals 101_1 to 101_N may be designed to sequentially and automatically carry out a sequence of arithmetic or logical operations; equipped to record/store digital data on a machine readable medium; and transmit and receive digital data via one or more network devices. Client terminals 101_1 to 101_N may include devices such as desktop computers, laptop computers, cellular phones, tablet personal computers, and/or any other physical or logical device capable of recording, storing, and/or transferring digital data via a connection to a network device. Client terminals 101_1 to 101_N may include a wireless transceiver configured to operate in accordance with one or more wireless standards.

The smart design system 100 according to example embodiments may be connected to at least one database (DB), e.g., databases 102 and 103. One of the at least one database (e.g., the database 102), may provide various information related to the business model 10 to the smart design system 100 by communicating with the smart design system 100 via the network. The other database 103 may provide various information to the smart design system 100 by communicating with the smart design system 100 via an internal network, such as a Wide Area Network (WAN) or other like network that covers a broad area, such as a personal area network (PAN), local area network (LAN), a virtual local area network (VLAN), or other like networks capable of physically or logically connecting computers. Although not shown, a database may further be included in the smart design system 100. The databases 102 and 103 may be stored on or otherwise associated with one or more data storage devices. These data storage devices may include at least one of a primary storage device, a secondary storage device, a tertiary storage device, a non-linear storage device, and/or other like data storage devices. Furthermore, the databases 102 and 103 may include one or more virtual machines, such that the physical data storage devices containing the databases 102 and 103 may be logically divided into multiple virtual data storage devices and/or databases. Alternatively, each of the databases 102 and 103 may reside on one physical hardware data storage device.

The smart design system 100 and the business model 10 including the smart design system 100 according to example embodiments may recommend to a client a product or a product group detected by fluidly reflecting the client's opinions, and may provide the client with various detailed information associated with the product so that the client may select an optimal product. Also, the smart design system 100 and the business model 10 including the smart design system 100 may enable a product selected by the client to be smoothly purchased on-line, thereby improving the efficiency of a transaction and increasing sale profits of an enterprise that has managed the smart design system 100.

To this end, the smart design system 100 and the business model 10 including the smart design system 100 may provide a function of designing and simulating an environment in which a product that the client desires to buy is to be used (e.g., an application such as a mobile device, etc.), and a function of recommending an appropriate product to the client according to any of various manners, based on a simulation result. Also, the smart design system 100 and the business model 10 including the smart design system 100 may enable information associated with a selected product to be shared with the client and provide a project plan function of relatively comparing a schedule of the selected product (e.g., a production schedule of the product) with the client's schedule so that information related to the schedule of the product may be shared with the client, thereby increasing the client's feeling of satisfaction. Furthermore, the client may use the smart design system 100 and the business model 10 including the smart design system 100 to design an application and/or device that includes the selected product; the client may then have the application and/or device including the selected product manufactured or otherwise produced according to the application and/or device design.

It should be noted that, according various example embodiments, a seller sells a product via the smart design system 100 and a client buys a part of a device, such as a smart phone and/or a tablet. Accordingly, when example embodiments are described herein, the terms, ‘product’ and ‘part’ are considered as having the same or similar meaning and may thus be used interchangeably with each other.

Operations of the smart design system 100 according to example embodiments will now be described in detail.

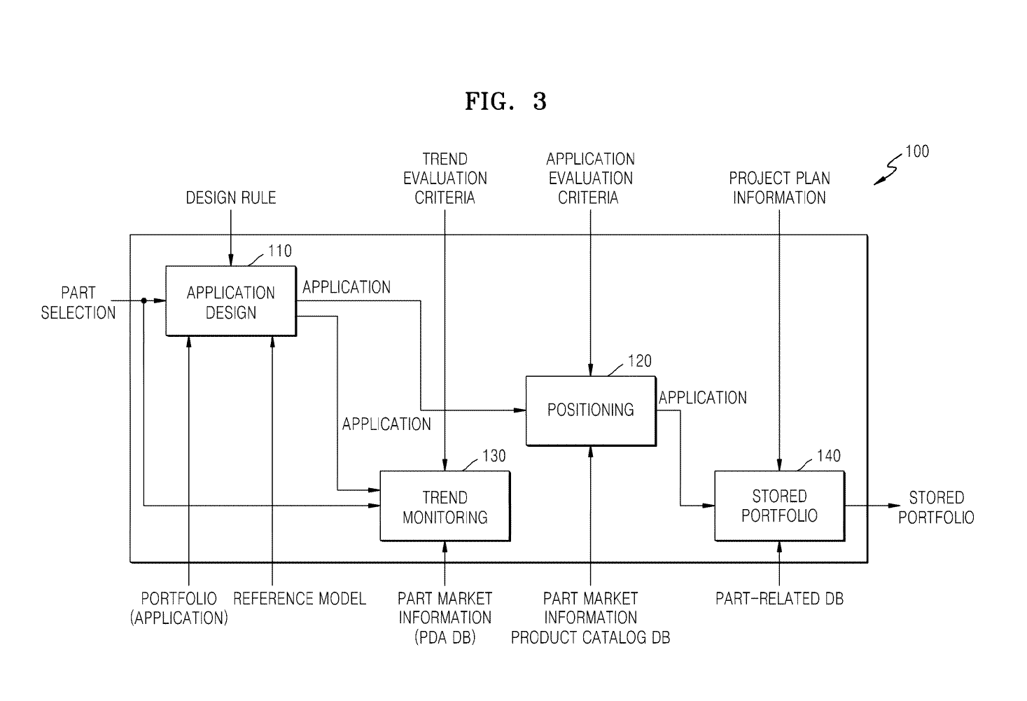

FIG. 2 is a block diagram illustrating operations of the smart design system 100 of FIG. 1 according to example embodiments.

As illustrated in FIG. 2, the smart design system 100 not only receives various information and request information/selection information transmitted from the client (e.g., at least one of the client terminals 101_1 to 101_N) but also provides a guide for the client to select a product through a simulation using the received information. For example, the smart design system 100 may receive various information related to an application design, e.g., information related to a product selected by the client (application design). Also, the smart design system 100 provides an application and/or device design function using a reference model, and receives information related to reference models related to various applications and/or devices to provide the application and/or device design function. The smart design system 100 may provide the application and/or device design function by using application information (e.g., the client's portfolio) that is stored beforehand by the client. Also, information related to various rules (e.g., design rules) for designing an application and/or device may be provided to the smart design system 100.

In addition to the application and/or device design function, the smart design system 100 according to example embodiments may analyze positioning of an application and/or device designed by the client, provide an analysis result, and/or provide a result of analyzing a market trend of an application and/or device related to the client (or products included in the application). To this end, detailed product information related to products to sell and various evaluation criteria for evaluating a designed application and/or device may be provided to the smart design system 100. Also, various information related to application and/or device design for each of clients or the client's history may be stored in the smart design system 100. Also, project plan information (project plan) for managing a schedule of a selected product and the client's schedule to be associated with each other may be provided to the smart design system 100.

The smart design system 100 generates information containing a result that provides a guide for the client to select a product from the various information. For example, when the client designs an application and/or device by selecting at least one product (e.g., parts included in the application and/or device), the smart design system 100 may generate an analysis result (positioning) by analyzing positioning of the designed application in a market. Also, the smart design system 100 may search for a market trend of a product selected by the client and generate a search result (market trend), based on the received various information. A result of analyzing the market trend may be a result of searching for information related to the market trend in units of market categories such as, countries, regions, age groups, gender, and/or other like market categories. Thus, the client may change a selected product by referring to a positioning analysis result and a result of searching for a market trend (positioning and market trend) and based on various recommendation information provided by the smart design system 100, thereby improving positioning and competitiveness of the client's application and/or device in the market. Also, order information regarding at least one product through the above process may be received from the client, and information such as the price and delivery date of the at least one product may be output and provided to the client. The order information received from the client may include various information related to the at least one product (e.g., information related to a supply date on the client desires to receive the at least one product).

FIG. 3 is a block diagram illustrating operations of elements of the smart design system 100 illustrated in FIG. 2 according to example embodiments.

As illustrated in FIG. 3, the smart design system 100 may include a first functional block 110 configured to design an application and/or device, a second functional block 120 configured to analyze positioning of the designed application and/or device, a third functional block 130 configured to monitor a market trend of products selected by the client, and a fourth functional block 140 configured to store and manage a portfolio related to an application and/or device for each of clients. The functions of the first to fourth functional blocks 110 to 140 are organically connected to be influenced by one another.

The first functional block 110 may receive information regarding various selected products (or part selection information denoted by ‘part selection’) from the client, and design an application and/or device according to design rules defined beforehand using the selected products. One application and/or device may be designed by selecting at least one product therefor. For example, one application and/or device may be designed by selecting and combining a plurality of products. Also, various options may be provided to design an application and/or device. For example, various reference models may be defined with respect to an application and/or device that the client desires to design. When the client selects one reference model, a function of selecting products included in the reference model is provided and the application and/or device may be designed when the client selects the products. Otherwise, design of the application and/or device may start when the client selects a new portfolio. Otherwise, the design of the application and/or device determined by the client may be stored in the smart design system 100, and the application and/or device may be designed when the client selects a portfolio that is stored beforehand.

The second functional block 120 analyzes positioning of the application and/or device designed by the first functional block 110. To this end, various evaluation criteria for each of applications and/or devices are provided to the second functional block 120. For evaluation, the second functional block 120 may calculate product scores with respect to products selected by the client, and calculate evaluation scores of products (e.g., an application and/or device score) based on the product scores. To calculate the product scores, attribute scores of the products may be defined and a weight may be assigned to product attributes. The application and/or device score may be calculated by performing an arithmetic operation using the product scores and assigning the weight. Also, the second functional block 120 may not only analyze positioning of the application and/or device but also recommend various types of products applicable to the client's application and/or device. To this end, various market information and detailed information related to the products may be further provided to the second functional block 120.

The client may change selection information regarding a product by checking the positioning analysis result and the products recommended by the smart design system 100. The design of the application and/or device may be determined through the above process. When a portfolio is requested by the client to be finally stored, the fourth functional block 140 may manage storing and registering of the portfolio. Together with the storing of the portfolio, various information related to the products selected by the client and project plan information for managing the schedules of the selected products and the client's schedule to be associated with one another may be stored.

The third functional block 130 monitors a trend of the products included in the application and/or device designed by the first functional block 110. To this end, the trend of the products may be monitored by analyzing a change in the use of core products of the application and/or device in the market, based on an application and/or device that is the same as or similar to the designed application and/or device and that has been formally placed on the market. Also, the trend of the products may be differently analyzed according to a region. Thus, a change in the use of the products in a region that the client selects may be analyzed. Also, the trend of the products may be classified into several groups according to one or more desired evaluation criteria, and monitored by determining a group to which a market trend belongs among the several groups. Also, in order to handle the monitoring and classifying of the trend of the products as described above, market information or information used as criterion for evaluating the trend of the products may be provided to the third functional block 130.

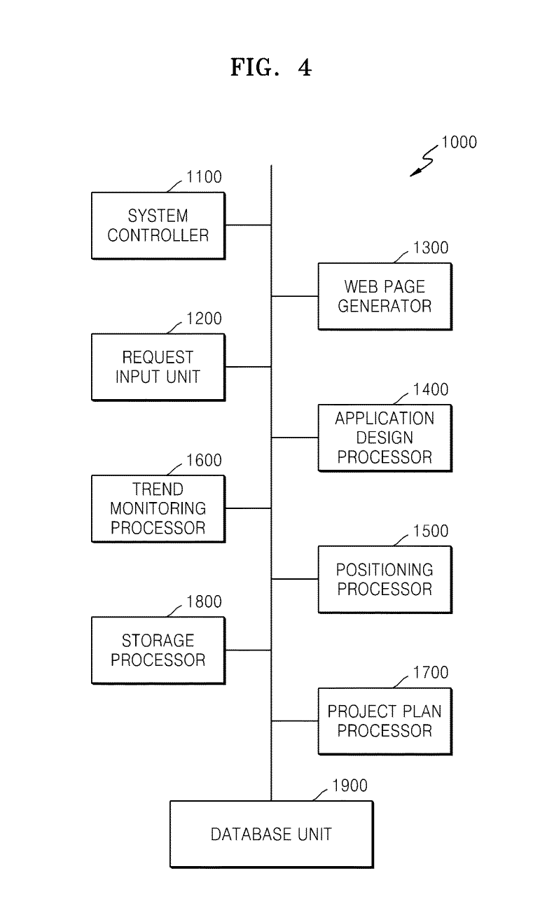

FIG. 4 is a block diagram of a smart design system 1000 according to example embodiments. As illustrated in FIG. 4, the smart design system 1000 may include a system controller 1100, a request input unit 1200, a web page generator 1300, an application design processor 1400, a positioning processor 1500, and a trend monitoring processor 1600. The smart design system 1000 may further include a project plan processor 1700, a storage processor 1800, and a database unit 1900 to manage the schedule of a selected product and the client's schedule to be associated with one another and to store and manage the client's portfolio. Although not shown in FIG. 4, according to various embodiments, multiple system controllers, multiple request input units, multiple web page generators, multiple application design processors, multiple positioning processors, multiple trend monitoring processors, multiple project plan processors, multiple storage processors, and/or any number of databases may be present. Additionally, in various embodiments, the aforementioned processors and/or databases may be virtual machines, and/or they may be provided as part of a cloud computing service. Furthermore, in some embodiments, the aforementioned processors and/or databases may reside on one physical hardware device. In various embodiments, the aforementioned processors and/or databases may be operate as hardware and/or software modules or units that are implemented on a single physical hardware device.

The system controller 1100 controls overall operations of the smart design system 1000. In some embodiments, the system controller 1100 controls overall operations of the smart design system 1000 to perform functions provided by the smart design system 1000 (e.g., application and/or device design), positioning analysis, trend monitoring, etc. The request input unit 1200 may receive various selection information and request information from the client terminal via a network. The request input unit 1200 provides various request information/selection information provided by the client who uses services provided from the smart design system 1000, to the inside of the smart design system 1000. Also, the web page generator 1300 creates a web page enabling the client to perform a function of inputting various request information/selection information, an application and/or device design function, and a function of outputting an analysis result so as to provide the client with information related to various products and a function of selecting a product to buy, via the web page. Although FIG. 4 illustrates that the web page is provided to the client, example embodiments are not limited to information in the form of a web page, and any other type of infothiation that may be displayed in the client's terminal may be provided to the client.

The application design processor 1400 performs design processing of an application and/or device based on various selection information of the client as described above. For example, the client may select a mobile device, such as a smart phone, a tablet, and/or other like device, or the like device as an application, and a plurality of architectures may be defined beforehand for mobile devices and the client may select one of the plurality of architectures. Thus, as used herein, the term “application design” may refer to designing one or more components, modules, units and/or other like portion of a hardware computing device and/or a software application. Also, products that are to be applied may be defined based on each of the plurality of architectures, and application design may be performed according to a product selected by the client. For example, when a smart phone, a tablet, and/or other like device is selected as an application, a chipset, a random access memory (RAM), a storage unit, a display, etc. may be applied as products.

The positioning processor 1500 may analyze positioning of an application selected and designed by the client in a market as described above. When a smart phone, a tablet, and/or other like device is selected, scores of respective products that are to be applied (e.g., a chipset, a RAM, a storage unit, and/or a display, may be calculated) may be defined. Also, at least one factor may be defined for each of the chipset, the RAM, the storage unit, the display, and/or other like application and/or component. For example, a factor related to the performance of each of the products may be defined. The positioning of the application may be analyzed by assigning a weight to each of factors, a score of each of the products selected by the client may be calculated using the defined factor, the weight, etc., and a score of the application may be calculated by performing an arithmetic operation on the scores of the products.

Also, the positioning processor 1500 may provide a result of searching for at least one recommended product to be applied to the application, based on a result of analyzing the positioning of the application. Various products applicable to the application may be searched for, and at least one other product may be recommended to increase a score of the application. In another embodiment, if the client desires to design a low-performance application, when only one product from among products of the application has a high performance, this may not satisfy the client's intention. In this case, a product may be recommended to lower a product score.

The trend monitoring processor 1600 may monitor a trend of an application that is selected and designed by the client as described above. When a smart phone, a tablet, and/or other like device is selected as an application, a change in the use of a chipset, a RAM, a storage unit, and a display employed as core products in the application may be analyzed and an analysis result may be provided as a result of monitoring the trend monitoring. To this end, a change in the use of the selected smart phone or table may be analyzed in a region selected by the client, based on a plurality of smart phones or tablets that have been formally placed on the market, and an analysis result may be provided. Such information related to a market trend may be collected from a server that is located outside the smart design system 1000 and configured to provide various data, or may be collected elsewhere outside and stored in the database unit 1900 of the smart design system 1000. Otherwise, the market trend may be monitored by using such information collected using another delivery path.

Thus, the client may determine whether the products applied to the application desired by him/herself correspond to or only slightly correspond to trends in various regions (e.g., worldwide, China, Asia, America, Europe, etc.), based on the result of monitoring the trend.

The project plan processor 1700 may manage a schedule of a product selected by the client (e.g., a manufacturing schedule of the selected product) and the client's schedule to be associated with each other, as described above. The storage processor 1800 may manage an application, which is designed by the client as a portfolio, to be stored in the database unit 1900, changed, or deleted, or manage storing of other various information. The database unit 1900 may store various basic information to provide functions such as an application design, positioning processing, trend monitoring, and a project plan, and various information selected by the client.

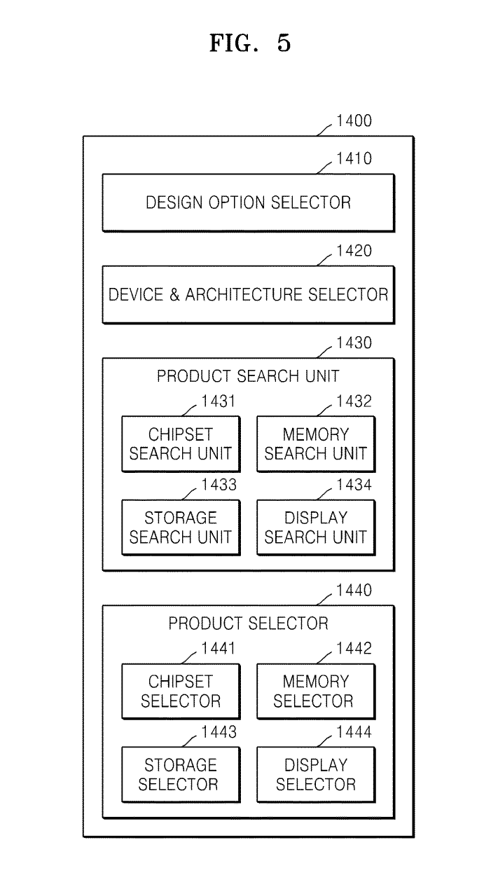

FIGS. 5 to 8 are block diagrams of the structures of some elements of the smart design system 1000 of FIG. 4 according to example embodiments.

As illustrated in FIG. 5, the application design processor 1400 may include a design option selector 1410, a device & architecture selector 1420, a product search unit 1430, and a product selector 1440. The product search unit 1430 may include a chipset search unit 1431, a memory search unit 1432, a storage search unit 1433, and a display search unit 1434. The product selector 1440 may include a chipset selector 1441, a memory selector 1442, a storage selector 1443, and a display selector 1444.

It is hereinafter assumed that the application described above is a device (e.g., a mobile device, a tablet personal computer, and the like) such as a smart phone, a tablet, and/or other like device. Since products may be parts employed in the smart phone or the tablet in this case, the terms ‘product’ and ‘parts’ may be understood as having the same or similar meanings. Although a chipset, a memory, a storage unit, and a display are presented herein as examples of products included in the smart phone or the tablet, it should be apparent to those of ordinary skill in the art that other products applicable to the device may be searched for, selected, and implemented.

The design option selector 1410 performs an application design according to one of a plurality of options, based on an item selected by the client. For example, when an application is designed, whether a reference model is to be used, whether a portfolio that is stored beforehand by the client is to be used, or whether a new portfolio is to be generated may be provided as an option. If the client desires to design a device and/or application using a reference model, the client may select one of various reference models of a smart phone. For example, reference models of a smart phone may be classified into ultra high end, high end, mid, low, and ultra low according to performance, and the application may be designed by selecting one of the reference models by the client.

When the smart phone is displayed according to the reference model selected by the client and the client selects parts to be included in the device and/or application, the application is designed based on information regarding the selected parts. If a portfolio that is stored beforehand is selected and used, some parts of the application according to the selected portfolio may have already been selected and applied by the client and the application may be thus continuously designed when the client selects and applies other parts. Otherwise, the smart phone may be designed starting from an initial stage by generating a new portfolio.

The device & architecture selector 1420 causes a device and architecture selected by the client to be applied to the design of the application. For example, an application that is to be designed may be determined by selecting a device. For example, a smart phone, a tablet, and/or other like device may be selected as an application as described above. Also, a plurality of architectures may be defined for each of devices, and the client may select one of the plurality of architectures to be applied to the design of the application. For example, when a smart phone is designed, various architectures may be provided according to a design manner or structure of the smart phone and the smart phone may be designed according to an architecture selected by the client.

The product search unit 1430 may search for various products to be applied to the application and output a search result onto a web page. Also, the product selector 1440 performs production selection to apply a product selected by the client to the design of the application. When a smart phone, a tablet, and/or other like device is defined as a device, the smart phone, tablet, and/or other like device may be designed using a chipset, a memory, a storage unit, and a display among parts included in the smart phone, tablet, and/or other like device. Thus, the product search unit 1430 may include a chipset search unit 1431, a memory search unit 1432, a storage search unit 1433 and a display search unit 1434. The product selector 1440 may include a chipset selector 1441, a memory selector 1442, a storage selector 1443, and a display selector 1444.

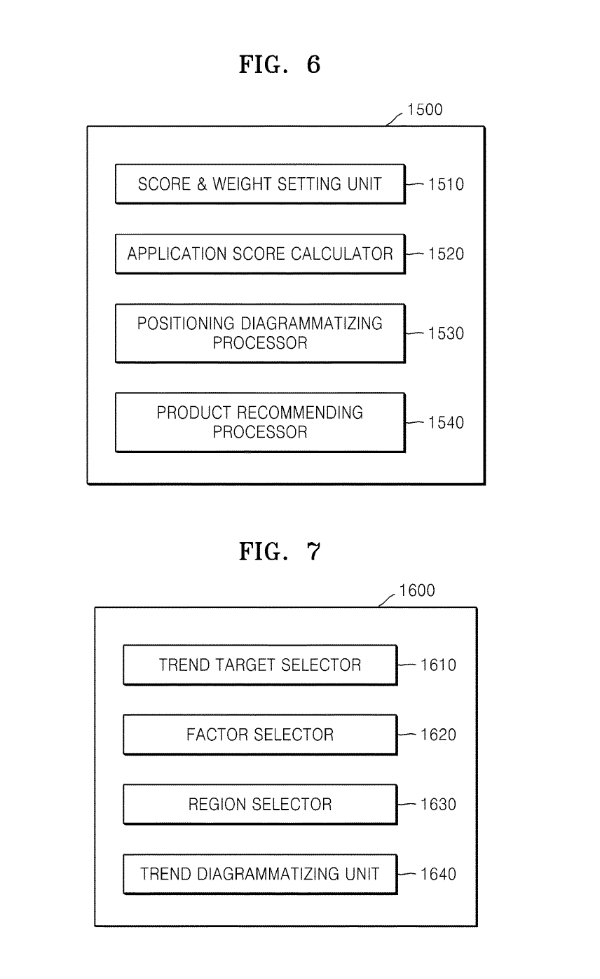

FIG. 6 is a block diagram of the positioning processor 1500 of FIG. 4 according to example embodiments. As illustrated in FIG. 6, the positioning processor 1500 may include a score & weight setting unit 1510, an application score calculator 1520, a positioning diagrammatizing processor 1530, and a product recommending processor 1540.

The score & weight setting unit 1510 sets various evaluation criteria for positioning analysis. For example, the score & weight setting unit 1510 may set a score for a factor (or an attribute) of each of products included in a device, and a weight to be assigned to the factor of each of the products. In the case of a smart phone, a tablet, and/or other like device, a score for a factor of each of a chipset, a RAM, a storage unit, and a display may be set. In the case of the chipset, a different score may be assigned according to the performance of the chipset (e.g., the number of cores and frequency characteristics). Also, different weights (e.g., product factor weights) may be set for the factors of a product. Also, different weights (e.g., product weights) may be set for each of a plurality of products included in the application. The scores and weights may be set differently according to a condition such as time or a region, and may be determined by a subject of operating the smart design system 1000.

The application score calculator 1520 calculates a score of an application designed by the client, based on the scores and weights for the products. For example, the score of the application may be calculated by calculating a product score for each of the products and performing an arithmetic operation by assigning a product weight to the product score. The positioning of the application may be analyzed according to a result of calculating the score of the application. The positioning diagrammatizing processor 1530 processes the positioning of the application to be output in the form of a diagram. The positioning of the application may be diagrammatized based on a product score for the products included in the application (or products selected by the client). The term “diagrammatize” may refer to any method of characterizing, symbolizing, or otherwise representing information according to one or more visualization techniques.

The product recommending processor 1540 determines whether another product needs to be recommended to the client based on a positioning result, and causes a more appropriate product to be recommended to the client based on a determination result. For example, a product having a high-specification factor may be recommended to relatively increase a high positioning, in consideration of the application score according to the products selected by the client. Also, products that are compatible with a device selected by the client from among various types of products may be recommended. As described above, detailed information regarding various products may be stored in the form of a database, and the detailed information may include information indicating whether each product and a device are compatible with each other. The information described above may be used to recommend products. When the client requests to change products, the product selector 1440 of FIG. 5 may change products to be applied to the application based on the change request information. In various embodiments, products may be recommended according to preset conditions and in any of various ways. For example, products may be recommended based on the specifications (e.g., high, mid, or low performance) of a reference model selected by the client. In some embodiments, a product having a high product score is likely to be recommended when the client selects a high-performance application model, and a product having a low product score is likely to be recommended when the client selects a low-performance application model.

Also, products may be recommended while reflecting priority over various elements. For example, a product may be recommended in consideration of a margin for the benefit of a product seller, or a product, the market share of which should be increased, may first be recommended. Otherwise, some products from among the plurality of products according to the positioning result may be recommended based on the priority.

Positioning analysis may be performed with respect to either the application selected by the client or another application. For example, information related to various applications may be used, and positioning of the application may be analyzed by searching for products of an application (or the specifications of the application) produced by a specific enterprise. Otherwise, a plurality of groups of applications may be defined based on the characteristics (or specifications) of the application, and the positioning of at least one group of applications may be analyzed according to the client's selection.

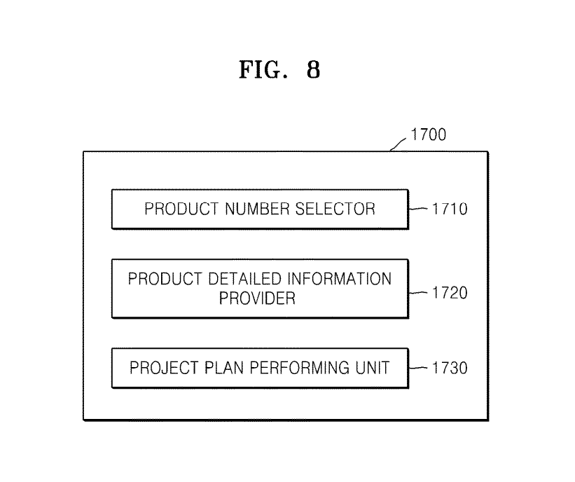

FIG. 7 is a block diagram of the trend monitoring processor 1600 of FIG. 4 according to example embodiments. As illustrated in FIG. 7, the trend monitoring processor 1600 may include a trend target selector 1610, a factor selector 1620, a region selector 1630, and a trend diagrammatizing unit 1640.

A result of monitoring a trend of a plurality of products applied to an application may be provided to a client. The client may select a product, whose result of trend monitoring the client desires to view, from among the plurality of products. The trend target selector 1610 selects a product on which trend monitoring is to be performed, in response to a request from the client. Also, the client may select at least one factor from among a plurality of factors defined for the selected product. The factor selector 1620 selects a factor on which trend monitoring is to be performed, in response to a request from the client. The trend diagrammatizing unit 1640 outputs a result of analyzing a trend in relation to the selected product and at least one factor in the form of a diagram. For example, one selected factor may be defined on the X-axis, another selected factor may be defined on the Y-axis, and the trend of the selected product may be plotted on a graph with the X-axis and the Y-axis.

Since the trend of a product may be analyzed differently according to a region, the region selector 1630 causes the client to select a region in which trend monitoring is to be performed, in response to a request from the client. For example, trend monitoring may be performed in units of countries or regions, or a trend of a specific enterprise may be monitored by searching for applications manufactured by the specific enterprise. Otherwise, a plurality of groups of applications may be defined based on the characteristics (or specifications) of the applications, and a trend of applications belonging to one group may be monitored according to the client's selection.

FIG. 8 is a block diagram of the project plan processor 1700 of FIG. 4 according to example embodiments. As illustrated in FIG. 8, the project plan processor 1700 may include a product number selector 1710, a product detailed information provider 1720, and a project plan performing unit 1730.

When a smart design service is provided, an application may be designed, and a client may be recommended a plurality of products using the smart design service and buy a desired product based on the recommended products. When a product purchase is registered, the client may be provided a function of searching for a project schedule of a product and a function of editing the project schedule. The project plan processor 1700 may perform such functions.

Information identifying a product, the project schedule of which is to be searched for, may be provided from the client. For example, the product number selector 1710 selects a product corresponding to a product number which is information input by the client. The project plan performing unit 1730 runs a project plan to provide the client with schedule information stored in relation to the selected product. The product detailed information provider 1720 may provide detailed information related to the project, the schedule of which is provided according to the project plan. For example, the client may be provided detailed information related to the characteristics of the product other than the schedule of the product.

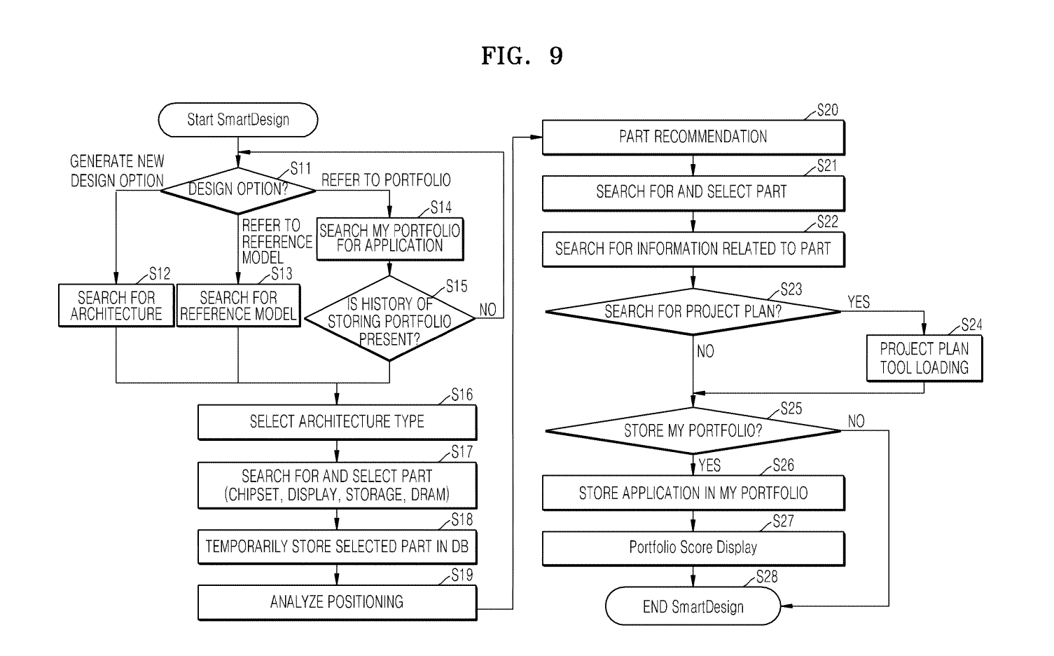

FIG. 9 is a flowchart illustrating whole operations of a smart design system according to example embodiments. As illustrated in FIG. 9, a smart design service may start to be provided when a client accesses the smart design system and passes user authentication. In FIG. 9, a smart phone, a tablet, and/or other like device may be applied as an application, and products described above such as a chipset, a display, a storage unit, and a dynamic random access memory (DRAM) may be applied as parts of the smart phone or the tablet.

When the smart design service starts, various options for designing an application are provided. As shown in operation S11, the smart design system determines a design option. In this case, the application is designed according to an option selected by the client. As shown in operation S12, the smart design system searches for an architecture, when the application is designed by generating a new portfolio, the smart design system searches for devices and architectures, the information of which is stored in a database using a device and an architecture selected by the client, and outputs a search result. Otherwise, as shown in operation S13, when a reference model option is ‘selected by the client, reference models may be searched for and a search result may be output. Otherwise, as shown in operation S14, when a portfolio option that is stored beforehand is selected by the client, portfolios that are stored beforehand are searched for and a search result is output. Then, as shown in operation S15, it is determined whether a history of storing the portfolio of the client who inputs a request is present. The application may be designed based on the stored portfolio when the history is present, and the client may be requested again to select a design option when the history is not present.

Then, as shown in operation S16, a result of searching for various types of architectures is output, and one of the various types of architectures is selected when a selection input is provided by the client. Then, as shown in operation S17, various products, parts, and/or components (hereinafter referred to as ‘products’) are searched for according to the type of selected architecture, a search result is output, and a product is selected when a selection input is provided by the client. For example, when the client selects the design of the smart phone or the tablet, a chipset, a display, a storage unit, and a RAM (e.g., a DRAM) may be searched for and selected as products. As shown in operation S18, information regarding the products selected by the client may be temporarily stored in a database. Also, according to various embodiments, and as shown in operation S20, when selection of a device and products is completed, a positioning of the designed application is analyzed, and various products considered as being suited to the client may be recommended based on an analysis result. As described above, whether products are compatible with devices may be considered when the products are recommended. Also, information may be classified according to factors (or performances) of products and stored in the form of a database, and may be searched for. Thus, appropriate products may be recommended in consideration of the positioning of the client.

Then, as shown in operation S21, a request to search for and select the recommended products may be input from the client, and these products may be searched for and selected in response to the client's request. As shown in operation S22, information related to the products requested by the client is searched for. Then, as shown in operation S23, it is determined whether a project plan is to be performed. As shown in operation 24, when the project plan is requested from the client to be performed, a tool for performing the project plan may be loaded as in the previous embodiments.

As shown in operation S25, when the designing of the application is completed, it is determined whether the design of the application is to be stored as the client's portfolio. As shown in operation S28, when the client selects not to store the design of the application, the smart design service ends without storing any information. As shown in operation S27, when the design of the application is requested to be stored as the client's portfolio, the design of the application may be stored in the client's portfolio, and at the same time, the score of the portfolio may be output. Then, the smart design service proceeds to operation S28 to end.

Operations of a smart design system described above in the previous embodiments will be described in detail below.

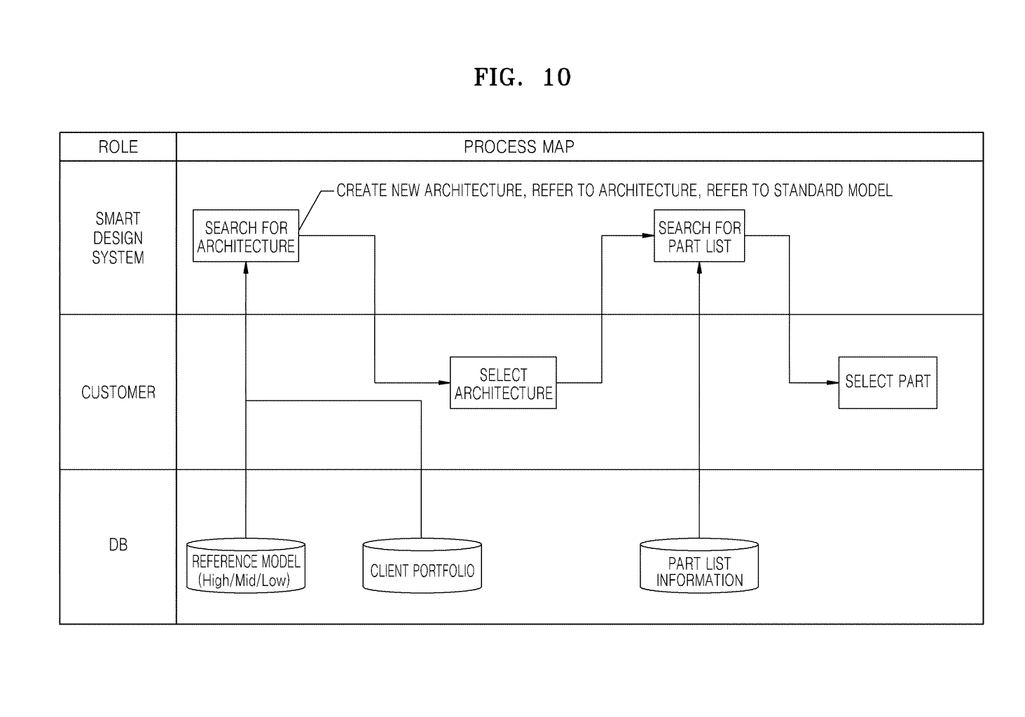

FIG. 10 is a conceptual diagram illustrating an operation of selecting a product according to example embodiments. In FIG. 10, this operation will be described in terms of a smart design system, a client, and a database.

To provide the client with an application design service according to various embodiments, the smart design system searches for various information stored in a database, and provides a search result. Various types of architectures may be defined for an application, and classified into a plurality of groups. For example, the architectures may be classified into high, mid, and low specification groups according to specifications. When the client selects a group from among the plurality of groups, architectures belonging to the selected group may be selectively searched for. Also, when a portfolio is selected by the client according to a design option, information regarding the client's portfolio stored in the database may be searched for and a search result may be output.

The client may check the searched information and select an architecture. When the client selects the architecture, the smart design system searches for information regarding various types of products that may be included in the architecture and outputs a search result. To search for a list of products, information regarding a product list stored in the database may be used and, and the client selects the products included in the architecture.

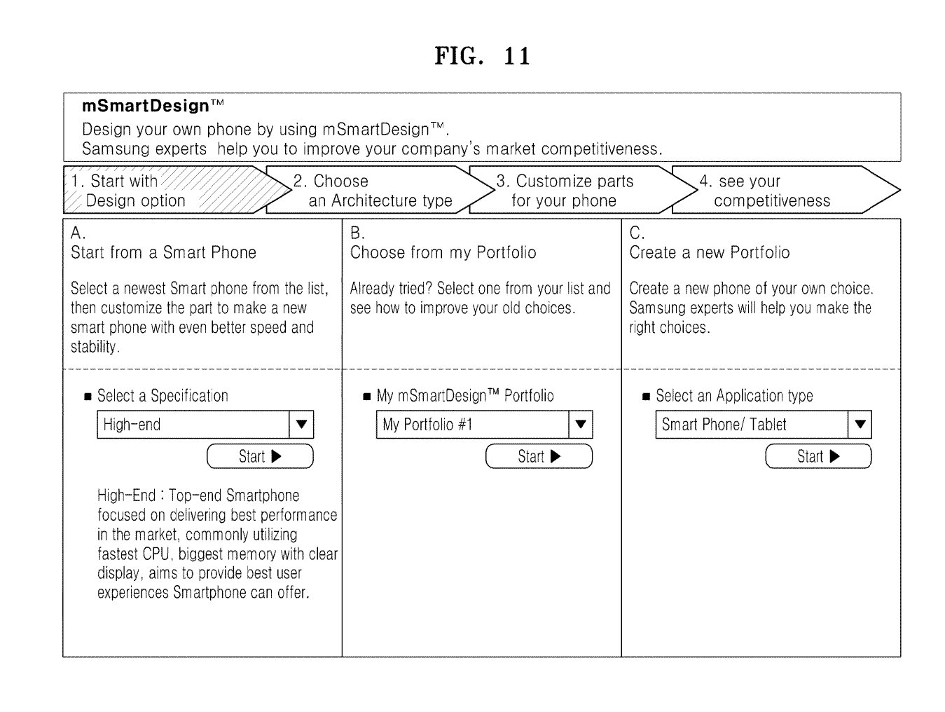

FIG. 11 is a diagram illustrating a web page screen image providing design options according to example embodiments. As illustrated in FIG. 11, when a client requests a smart design service, an authentication process is performed with respect to the client and a web page providing a function of selecting a design option is output. In various embodiments, three options A to C may be provided as described above. Option A provides reference models for a smart phone to design a smart phone. As described above, the reference models may be classified into several groups according to specifications. As an example, referring to FIG. 11, five specifications, e.g., high, mid, low, and ultra-low specifications, are provided. Also, when the client desires to design a tablet, a design plan service for a tablet may be provided using additional specifications.

Option B enables the client to design the smart phone using a portfolio that is stored beforehand as in the previous embodiments. Option C enables to generate a new portfolio for the client so that an application may be designed starting from an initial stage.

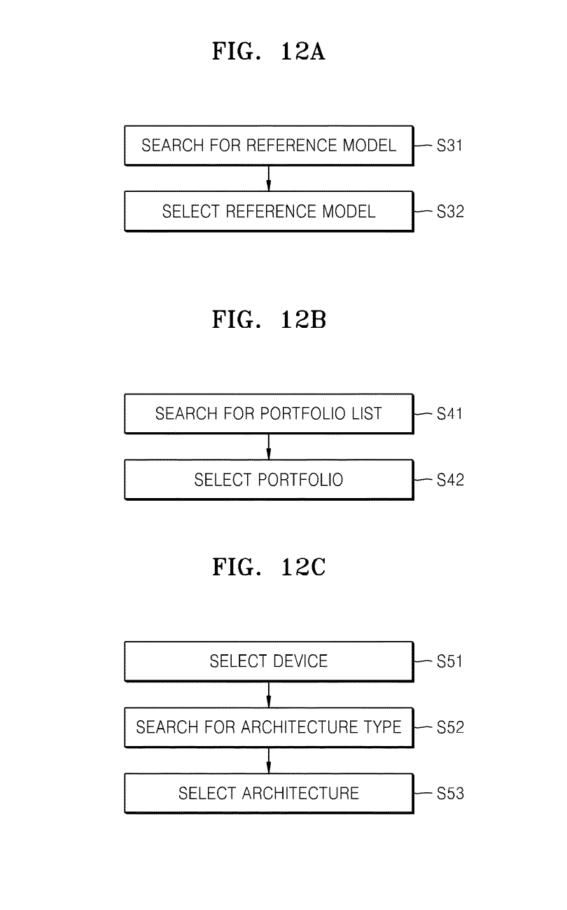

FIGS. 12A to 12C are flowcharts illustrating operations performed based on the concept of FIG. 11 according to example embodiments. As illustrated in FIG. 12A, when a device is requested to be designed using a reference model, a smart design system searches for various reference models stored in a database and outputs a search result, as shown in operation S31. Then, as shown in operation S32, when a client checks the search result and selects one of the reference models, the smart design system enables to select the reference model and perform a subsequent design operation.

As illustrated in FIG. 12B, when the client requests to design a device using a portfolio, the smart design system searches for a list of portfolios of clients stored in the database, as shown in operation S41. As shown in operation S42, a list including at least one portfolio corresponding to the client is output as a search result, and when the client selects one of the at least one portfolio, the smart design system selects the selected portfolio and performs a subsequent design operation.

Otherwise, as illustrated in FIG. 12C, when a new design is requested to be planned, the smart design system searches for various devices and outputs a search result, and when the client selects one of the devices, the smart design system selects the selected device, as shown in operation S51. Also, as shown in operation S52, various architecture types that are applicable to the selected device are searched for and a search result is output. As shown in operation S53, when the client selects one of the various architecture types, the smart design system selects the selected architecture type and performs a subsequent design operation.

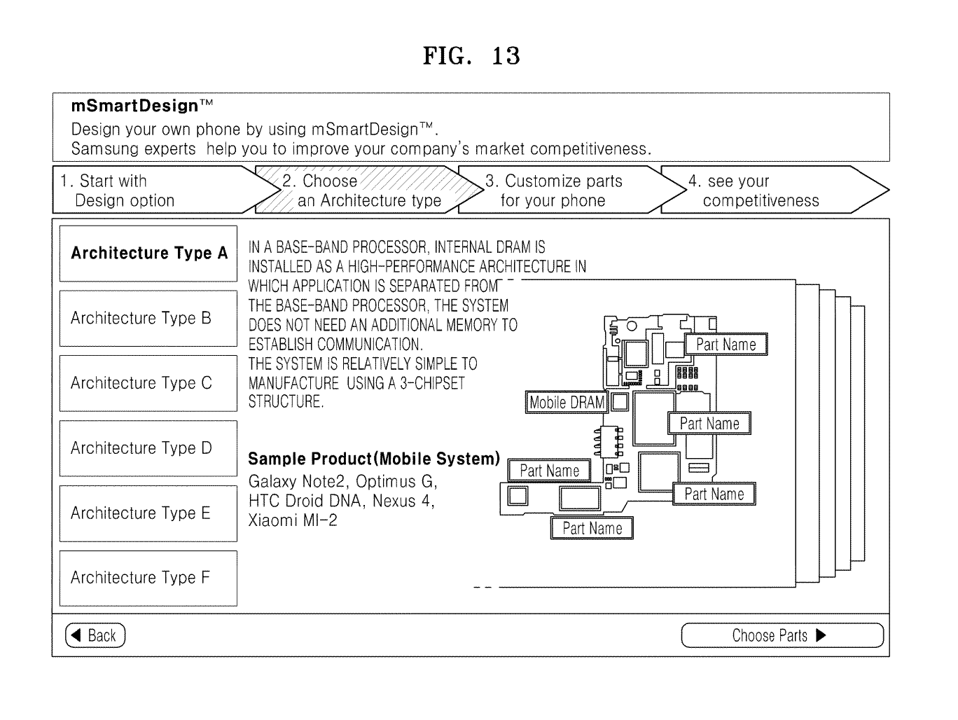

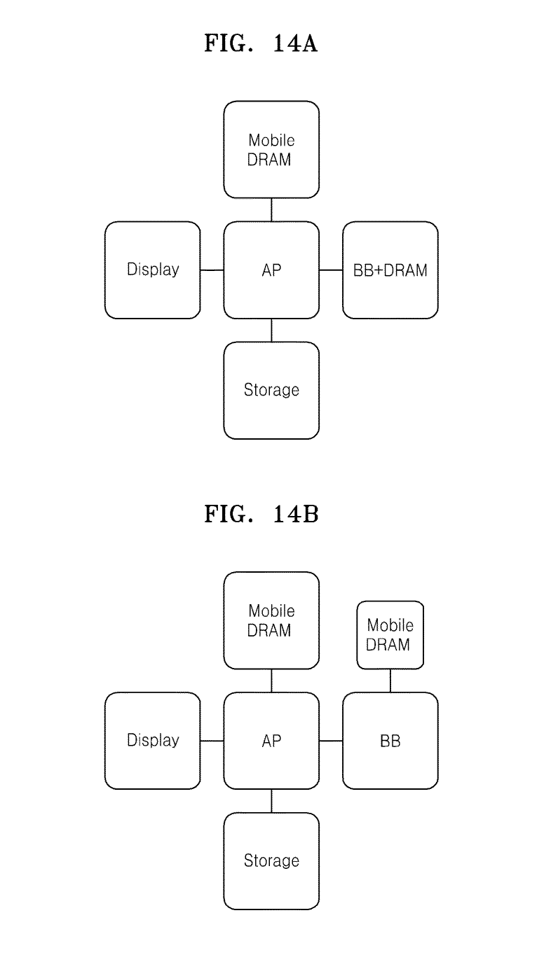

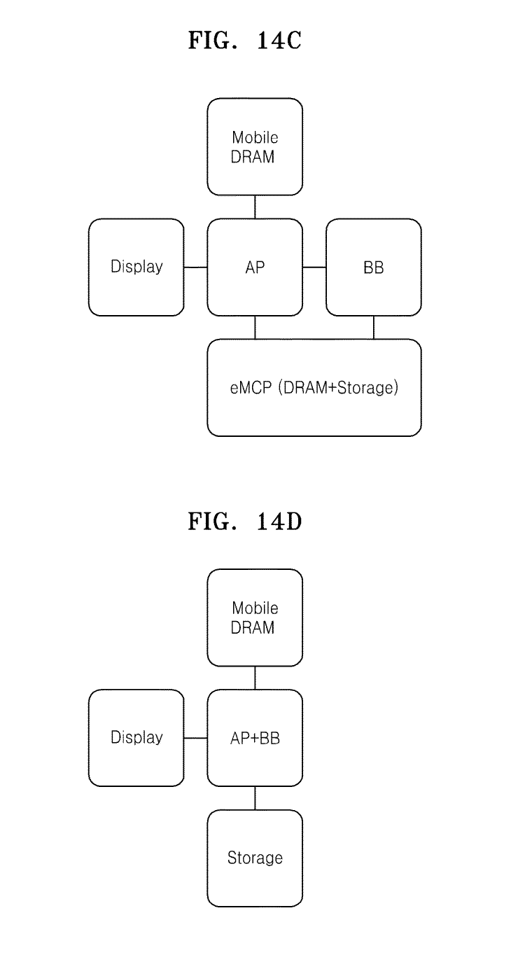

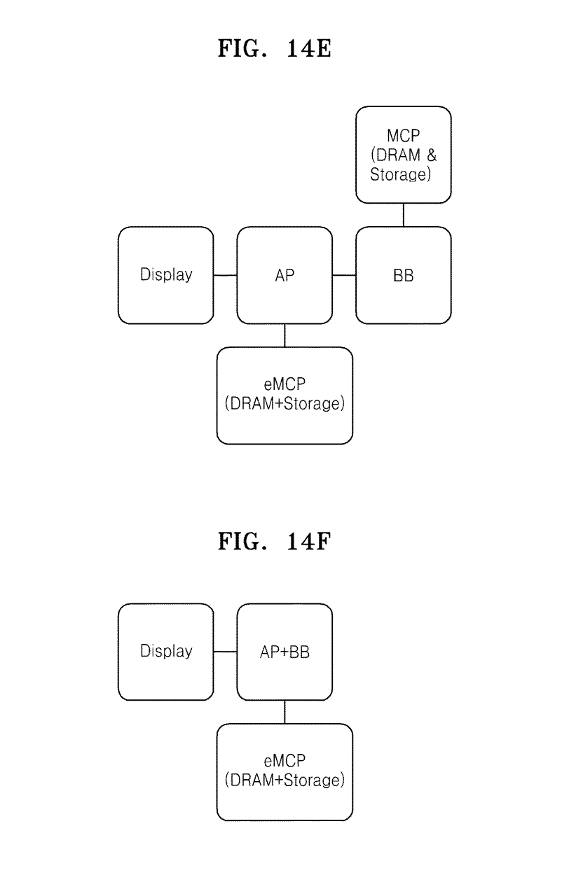

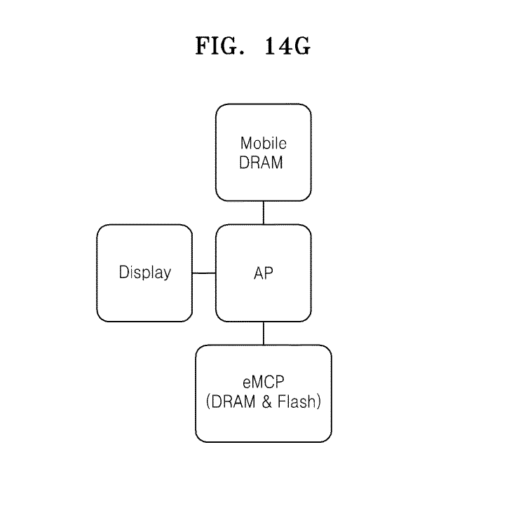

FIG. 13 is a diagram illustrating a web page screen image providing an architecture selection function according to example embodiments. FIGS. 14A to 14G are block diagrams of architecture types that may be defined for a smart phone according to various embodiments.

As illustrated in FIG. 13, when a device is selected using one of various options, various architecture types, e.g., Type A to Type F, related to the device may be searched for and selected. Also, brief drawings and descriptions of the various architecture types, e.g., Type A to Type F, may be displayed on one web page, and a guide helpful to the client's choice may be provided through the brief drawings and descriptions.

When a smart phone, a tablet, and/or other like device is selected as a device, various architectures may be defined for the smart phone, tablet, or other like device. For example, FIG. 14A illustrates architecture type A that may include a processor AP, a display, a mobile DRAM, a storage unit, and a combination of a baseband and DRAM BB+DRAM. Together with the structure of architecture type A, attributes of each of the products included in architecture type A, an example of a product to which architecture type A is applied, and the type of an application that is applicable may be displayed.

Similarly, architecture type B may include a processor AP, a display, a mobile DRAM, a storage unit, a baseband BB, and a mobile DRAM, in which the baseband BB and the mobile DRAM are combined unlike in architecture type A. Also, architecture type C includes a processor AP, a display, a mobile DRAM, a baseband BB, and a storage unit, in which one or more embedded multi-chip packages (eMCPs) including a DRAM may be applied as the storage unit. Similarly, a unique structure may be defined for each of architecture types D to architecture type G.

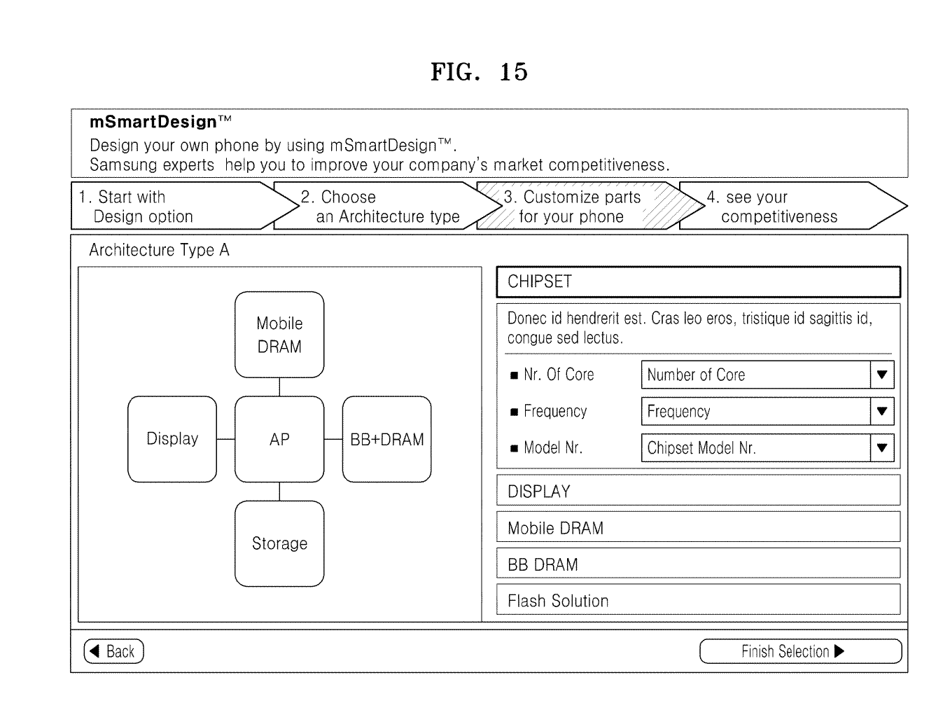

FIG. 15 is a diagram illustrating a web page providing a product selection function according to example embodiment. When a client selects an architecture of an application to be designed, a web page providing a product selection function of selecting a product according to the architecture is output as illustrated in FIG. 15. For example, a chipset, a display, a mobile DRAM, a combination of a baseband and a DRAM, and a storage unit included in the selected architecture may be selected, and for example, the number of cores, a frequency, and a model number may be selected as selection factors for a product, e.g., the chipset.

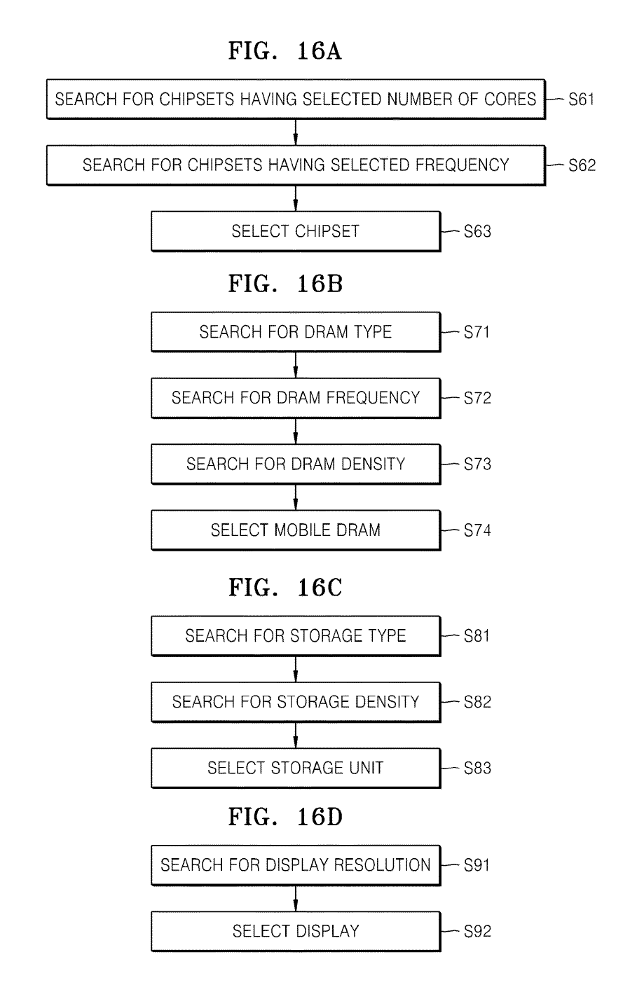

FIGS. 16A to 16D are flowcharts illustrating a method of selecting a product using the web page of FIG. 15 according to example embodiments. If it is assumed that products included in a selected architecture are a chipset, a mobile DRAM, a storage unit, and a display, the number of cores and a frequency may be defined as chipset selection factors as illustrated in FIG. 16A.

As shown in operation S61, when a factor related to the number of cores of a chipset is selected according to an input from a client, chipsets having the number of cores are searched for, based on the client's selection. Then, as shown in operation S62, when a factor related to a frequency of a chipset (or an operating frequency) is selected according to an input from the client, chipsets having the frequency are searched for based on the client's selection. Then, as shown in operation S63, search results are output to the client, and a chipset is selected according to an input from the client. Similarly, as illustrated in FIG. 16B, DRAM types, frequencies (or operating frequencies), densities, etc. may be searched for as DRAM selection factors as shown in operations S71, S72, and S73. Then, as shown in operation S74, a mobile DRAM is selected based on an input from the client.

Also, as illustrated in FIG. 16C, storage types and storage densities may be searched for as storage selection factors, as shown in operations S81 and S82. Then, as shown in operation S83, a storage unit may be selected based on an input from the client. Also, as illustrated in FIG. 16D, display resolutions may be searched for as display selection factors, as shown in operation S91. Then, as shown in operation S92, a display may be selected based on an input from the client.

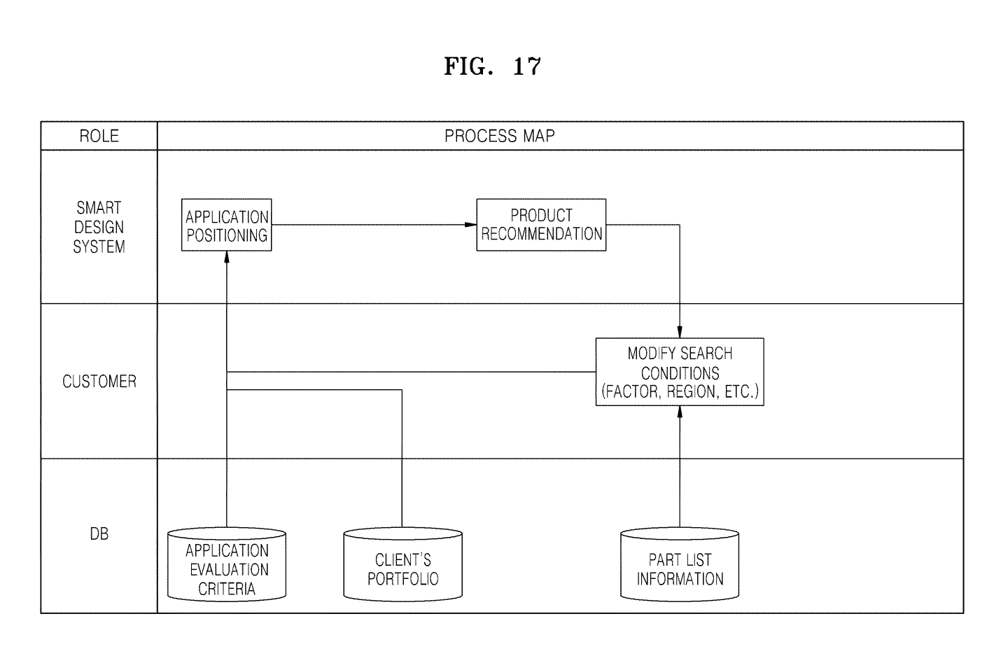

FIG. 17 is a conceptual diagram illustrating positioning and product recommendation according to example embodiments. These operations will be described in terms of a smart design system, a client, and a database with reference to FIG. 17 below.

A positioning result that may represent the competitiveness of a designed application in a market, and various criteria for evaluating an application designed by a client are stored in a database so that optimal products may be recommended to the client based on a positioning analysis result. The smart design system may analyze a positioning of the application based on the evaluation criteria stored in the database, and recommend products based on the positioning analysis result. A result of analyzing the positioning of the designed application may vary according to a region, and the positioning analysis result may be a result of analyzing a selected region. The client may change conditions of a search (e.g., product factors) that the smart design system performs to analyze a positioning, and change a region on which the positioning analysis is to be performed. When such a change input is received from the client, the smart design system performs the positioning analysis again by changing search conditions or a region, outputs a positioning analysis result, and then recommends products.

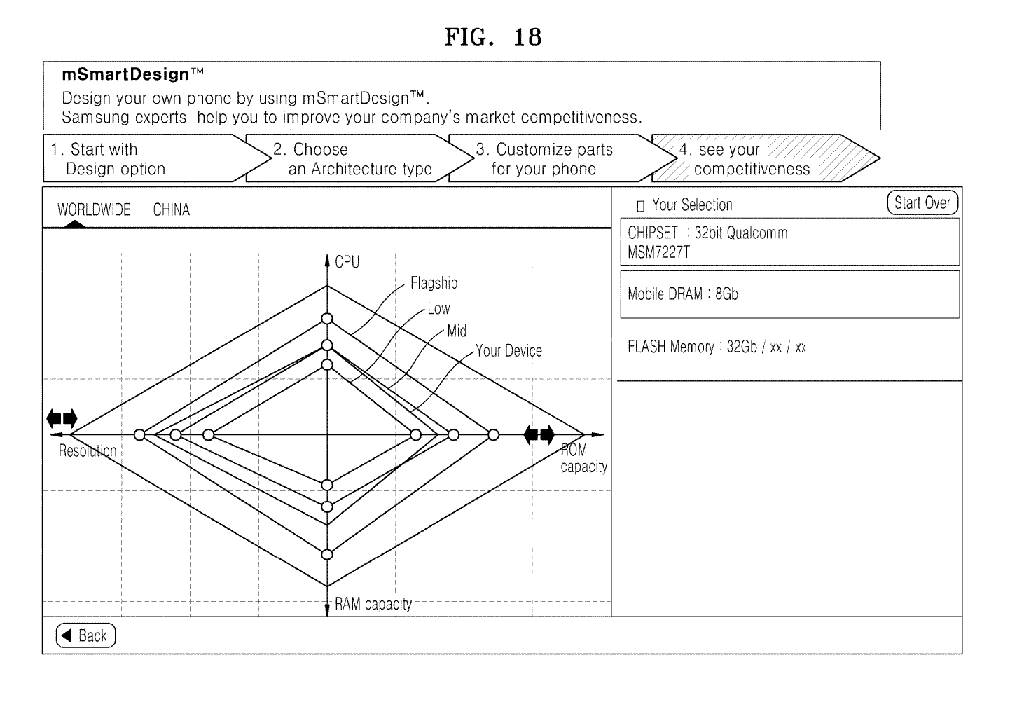

FIG. 18 is a diagram illustrating a web page screen image providing a positioning analysis result according to example embodiments. Positioning analysis may be performed on an application designed by a client in units of products included in the application. Also, as illustrated in FIG. 18, a positioning analysis result may be provided in units of regions (e.g., worldwide, China, etc.). The types of products selected by the client may be displayed at a side of the web page, and the positioning analysis result may be diagrammatized and displayed in the form of a graph.

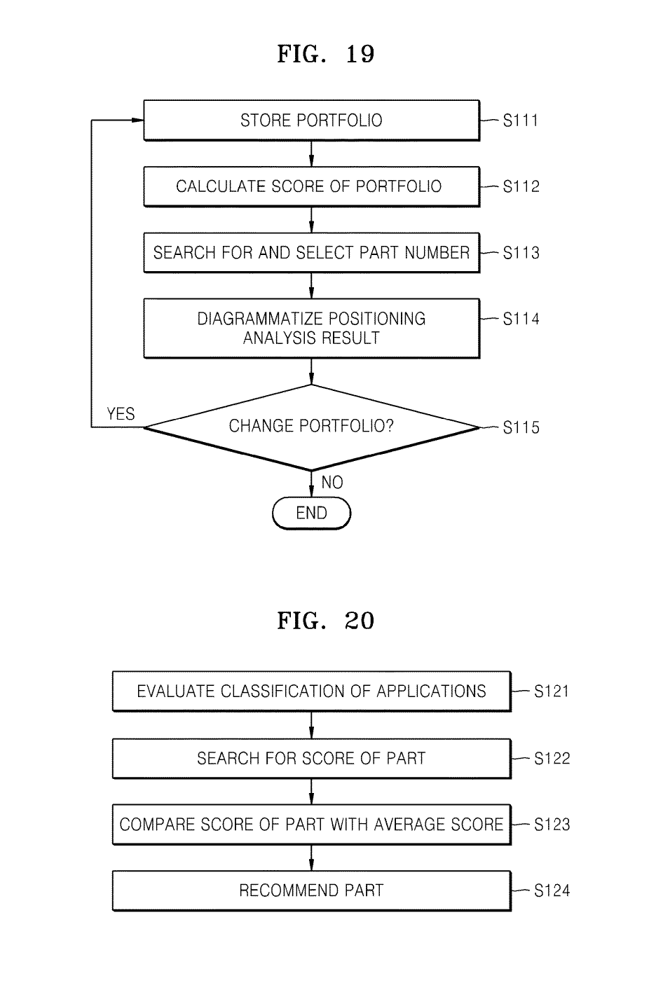

FIGS. 19 and 20 are flowcharts illustrating a positioning analysis method and a method of recommending products according to embodiments.

As illustrated in FIG. 19, an application designed by a client may be temporarily stored as the client's portfolio, as shown in operation S111. Then, as shown in operation S112, a score of the portfolio may be calculated based on various criteria for positioning analysis. Based on a positioning analysis result, other optimal products may be recommended to the client.

As shown in operation S113, to recommend products, at least one product that is to be recommended to the client is selected while information regarding various products stored in a database is searched for. As shown in operation S114, the positioning analysis result is diagrammatized and output. As shown in operation S115, if the client selects one of the recommended products, a positioning analysis result that reflects a changed product may be diagrammatized and output. Then, the client may select as to whether the portfolio is to be changed. The portfolio is stored and the positioning analysis is completed when a change in the portfolio is not requested, and the operations described above are repeatedly performed when a change in the portfolio is requested.

FIG. 20 illustrates sub operations related to product recommendation according to example embodiments. As illustrated in FIG. 20, classification of applications may be evaluated based on a positioning analysis result, as shown in operation S121. For example, applications may be classified into high, mid, and low-specification groups according to specifications of products therein, and a client may evaluate the type of a designed application according to the specifications of products therein.

Then, as shown in operation S122, scores of the products included in the application score may be searched for. For example, when an enterprise that provides a smart design service sells DRAMs and storage units, scores of a DRAM and a storage unit among the products included in the application may be searched for. Then, as shown in operation S123, the scores of the products may be compared with an average score. For example, an average score of a product, which is the same as the products, in a market may be calculated and compared with the searched scores. Then, as shown in operation S124, other products are recommended according to predefined rules, based on a comparison result. The model names of the recommended products may not be clearly stated but detailed information regarding the specifications of the recommended products may be provided. Also, when the client compares the scores of the selected products with the average score, the scores of the selected products may be compared with not only average scores for respective regions but also average scores for respective countries, respective markets, etc.

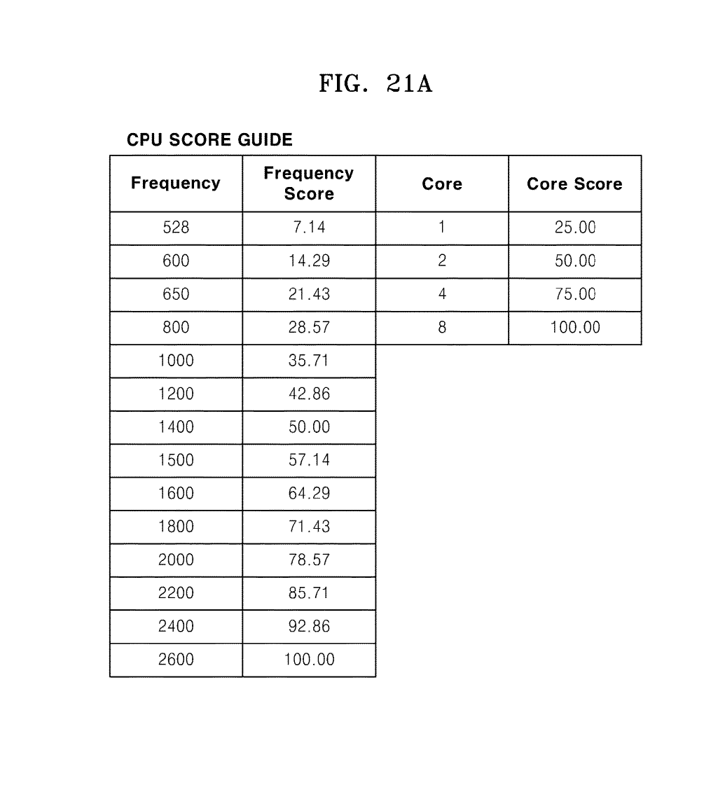

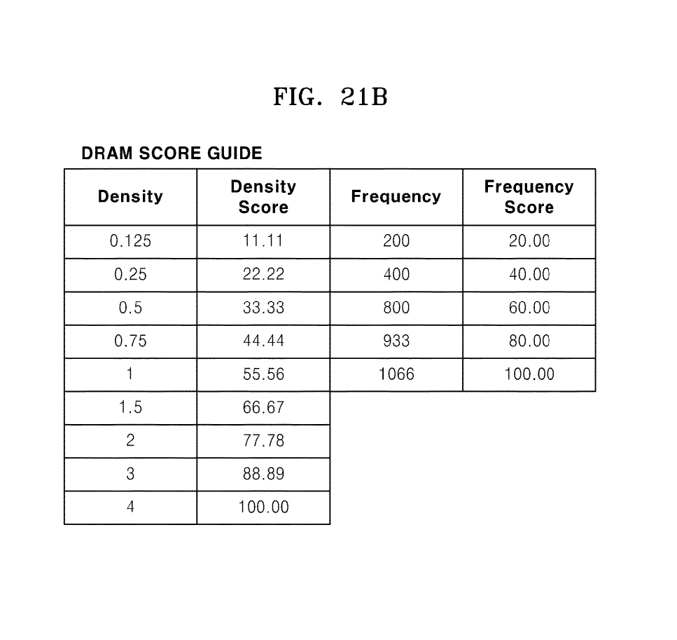

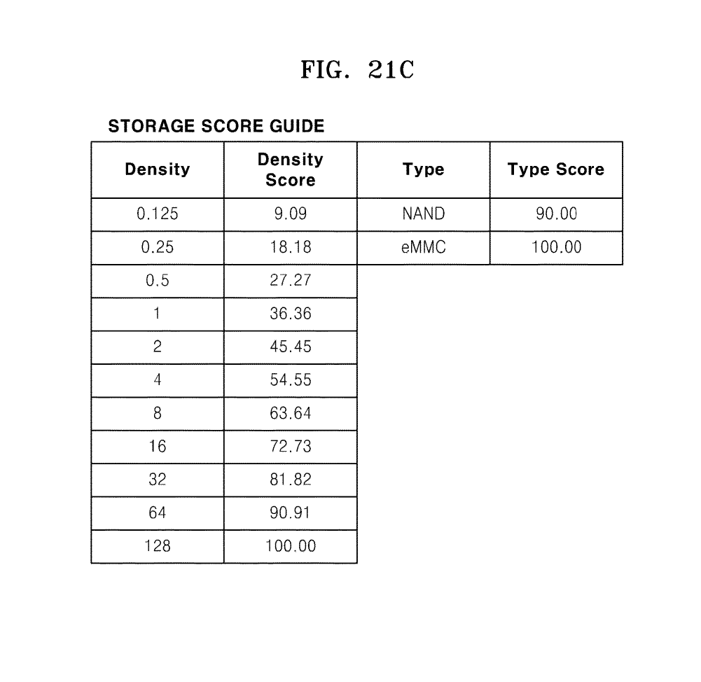

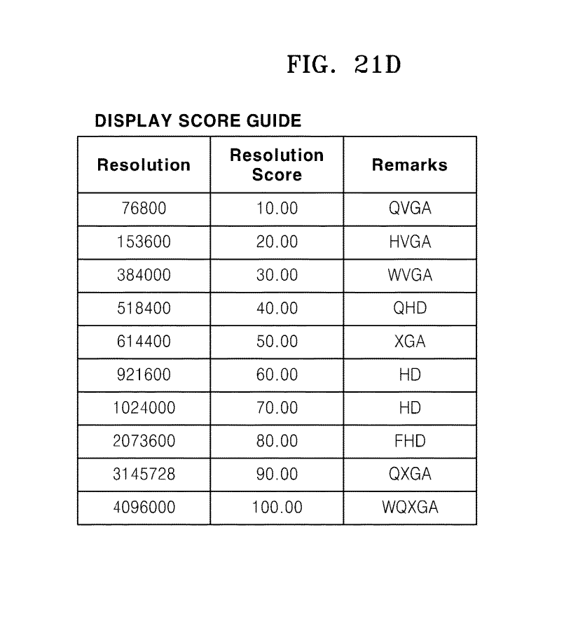

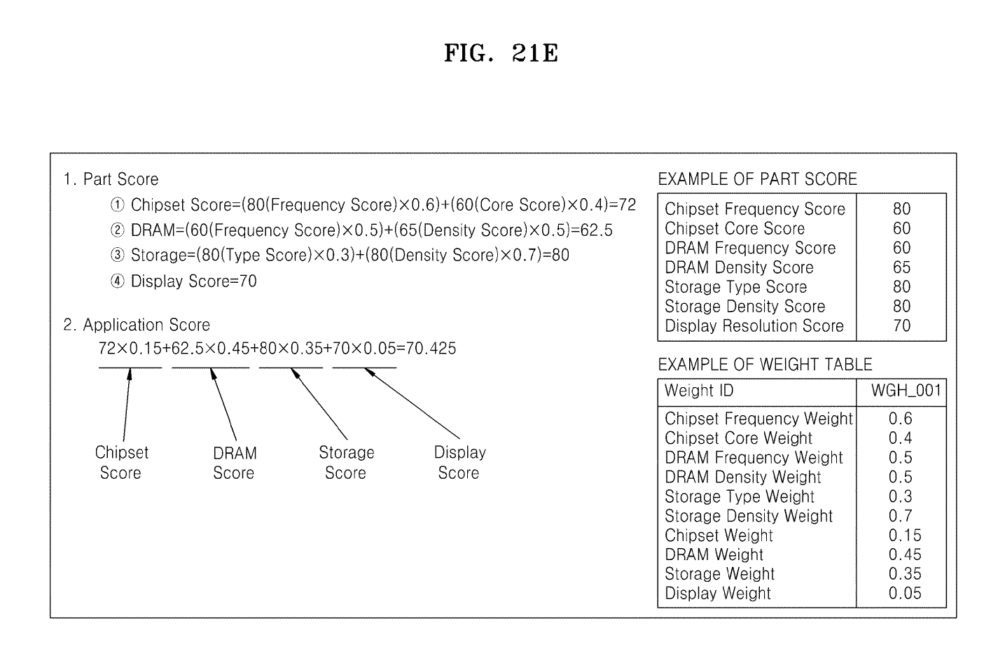

FIGS. 21A to 21E are tables illustrating scores and weights assigned to a plurality of products and a method of calculating a score of an application according to embodiments. For example, FIG. 21A illustrates scores assigned to a chipset such as a central processing unit (CPU), FIG. 21B illustrates scores assigned to a DRAM, FIG. 21C illustrates scores assigned to a storage unit, and FIG. 21D illustrates scores assigned to a display unit.

At least one factor may be defined for the chipset. For example, factors such as a frequency and the number of cores may be defined for the chipset. Product attribute scores may be assigned to the respective factors according to performances thereof. As illustrated in FIG. 21A, the higher the frequency of the chipset, the higher a product attribute score may be assigned. Also, the greater the number of cores, the higher a product attribute score may be assigned. Similarly, as illustrated in FIG. 21B, product attribute scores may be assigned to the DRAM according to a density that may relate to a storage capacity and a frequency related to an operating speed. The higher the density, the higher a product attribute score may be assigned. The higher the frequency, the higher a product attribute score may be assigned.

Similarly, as illustrated in FIG. 21C, product attribute scores may be assigned to the storage unit according to a density and type thereof. For example, the higher the density, the higher a product attribute score may be assigned. Also, a different product attribute score may be assigned according to the type of the storage unit. For example, when the storage unit is an embedded multimedia card (eMMC), a higher product attribute score may be assigned to the eMMc than to a NAND flash. Also, as illustrated in FIG. 21D, a different product attribute score may be assigned to the display unit according to the resolution thereof. For example, the higher the resolution, the higher the product attribute score that may be assigned.

FIG. 21E illustrates a method of calculating a score of an application according to example embodiments. As illustrated in FIG. 21E, product attribute scores may be assigned to factors of products according to performance thereof, and a product attribute weight may be assigned to each of the factors. Also, a product weight may be assigned to each of the products.

For example, in the case of a chipset, when it is defined that a product attribute score of a frequency selected by a client is ‘80’, a product attribute weight is ‘0.6’, a product attribute score of the number of cores selected by the client is ‘60’, and a product attribute weight is ‘0.4’, a product score of the chipset may be calculated to be ‘72’. Similarly, product scores of a DRAM, a storage unit, and a display may be calculated.

Also, a score of an application designed by the client may be calculated. For example, the score of the application may be calculated by performing an arithmetic operation on the product scores and weights assigned to the respective products (e.g., product weights). When ‘0.15’ is assigned to the chipset, ‘0.45’ is assigned to the DRAM, ‘0.35’ is assigned to the storage unit, and ‘0.05’ is assigned to the display as weights, the score of the application may be calculated to be ‘70.425’ as illustrated in FIG. 21E.

The sum of weights assigned to calculate at least one score (product score and/or application score) may be ‘1’. For example, the sum of a product attribute weight ‘0.6’ assigned to a frequency and a product attribute weight ‘0.4’ assigned to the number of cores, so as to calculate a score of the chipset, may be ‘1’. Also, the sum of a product weight ‘0.15’ assigned to the chipset, a product weight ‘0.45’ assigned to the DRAM, a product weight ‘0.35’ assigned to the storage unit, and a product weight ‘0.05’ assigned to the display, so as to calculate a score of the application, may be ‘1’.

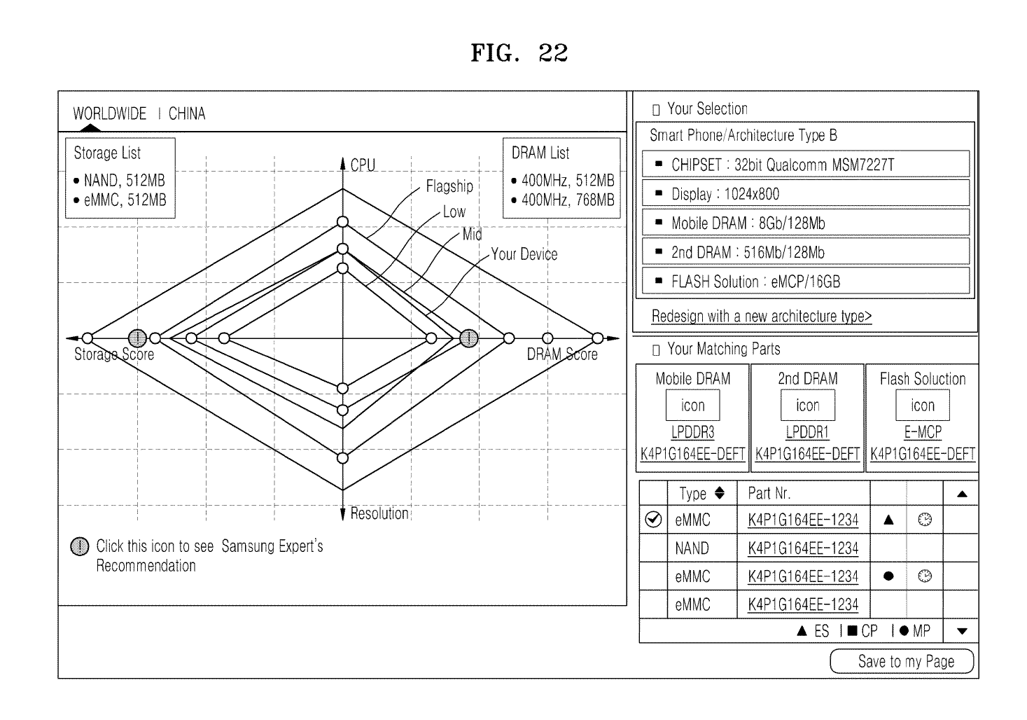

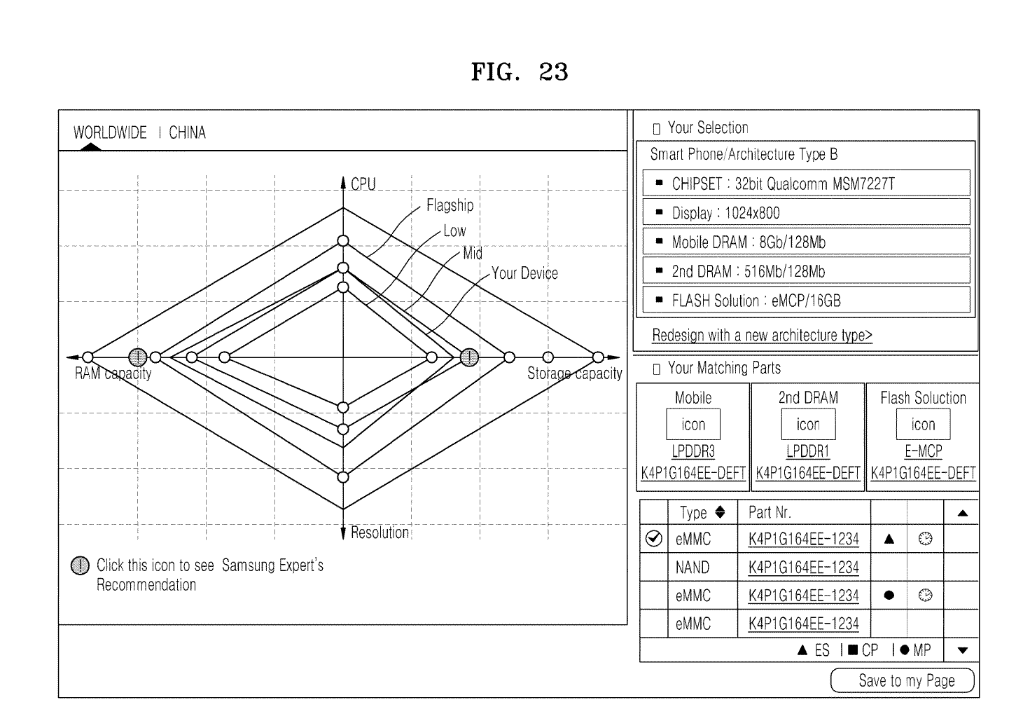

FIGS. 22 and 23 illustrate a result of diagrammatizing scores calculated based on results of analyzing positioning of products according to embodiments. As illustrated in FIG. 22, a score of each of products is calculated as a positioning analysis result and is diagrammatized and output in the form of a graph. At a side of the web page, the specifications of selected products may be displayed. Also, a list of other products corresponding to the specifications of products selected by a client may be displayed, searched for and selected.

In various embodiments, when a storage unit and a DRAM may be for sale by a smart design system, a storage unit and a DRAM that are to be recommended may be displayed on the graph. A list and specifications of a storage unit and a DRAM that are currently selected by the client may be displayed on the graph or at another side of the web page. Also, a figure obtained using scores of products selected by the client (hereinafter referred to as a figure of the client's application) may be displayed on the graph using a specific color.

Specifically, the figure of the client's application has a vertex on a point on the X-axis and a point on the Y-axis according to the scores of the storage unit, the DRAM, the chipset (or CPU), and the display (or the resolution of the display) selected by the client. For example, the figure of the client's application has a vertex on a point on an axis (e.g., an −X-axis) denoting the score (product score) of the selected storage according to the score of the storage, and a mark (e.g., ‘!’) denoting a recommended product may be put on another point on the axis (−X-axis). The recommended product displayed on the other point on the axis (−X-axis) may have a different product score from that of the currently selected storage. Thus, when the client selects the mark denoting the recommended product, another storage unit having a different specification may be selected. For example, the other storage unit may be selected by dragging the vertex of the figure denoting the score of the storage unit (e.g., the vertex on the −X-axis) to the mark denoting the recommended product.

The above operation may be similarly applied to the DRAM. Specifically, a vertex of a figure may be positioned on a point on an axis (e.g., +X-axis) denoting the score of a DRAM selected by the client according to the score of the selected DRAM, and a mark denoting a recommended product may be put on another point on the +X-axis. The client may select another DRAM having a different specification (different score) by dragging the vertex of the figure on the +X-axis to the mark denoting a recommended product for a DRAM.

Similarly, in FIG. 23, an axis of the graph denotes a specification of a product (e.g., the capacity of a DRAM or a storage unit) other than a score of the product, and a result of performing a positioning analysis on the capacity of a current storage unit and DRAM selected by the client may be diagrammatized and output in the form of a graph. To recommend a product having a different specification, a mark denoting the recommended product may be placed on a different point on the axis denoting the capacity of the DRAM or the storage unit, and the client may select the recommended product having the different specification by dragging a vertex of a figure displayed using a specific color on the graph, similar to the previous embodiment.

A product may be recommended according to preset criteria and in any of various ways. For example, a product may be recommended based on a specification (high, mid, low, etc.) of a reference model selected by the client. In various embodiments, a product having a high product score is likely to be recommended when the client selects a high-performance application model, and a product having a low product score is likely to be recommended when the client selects a low-performance application model.

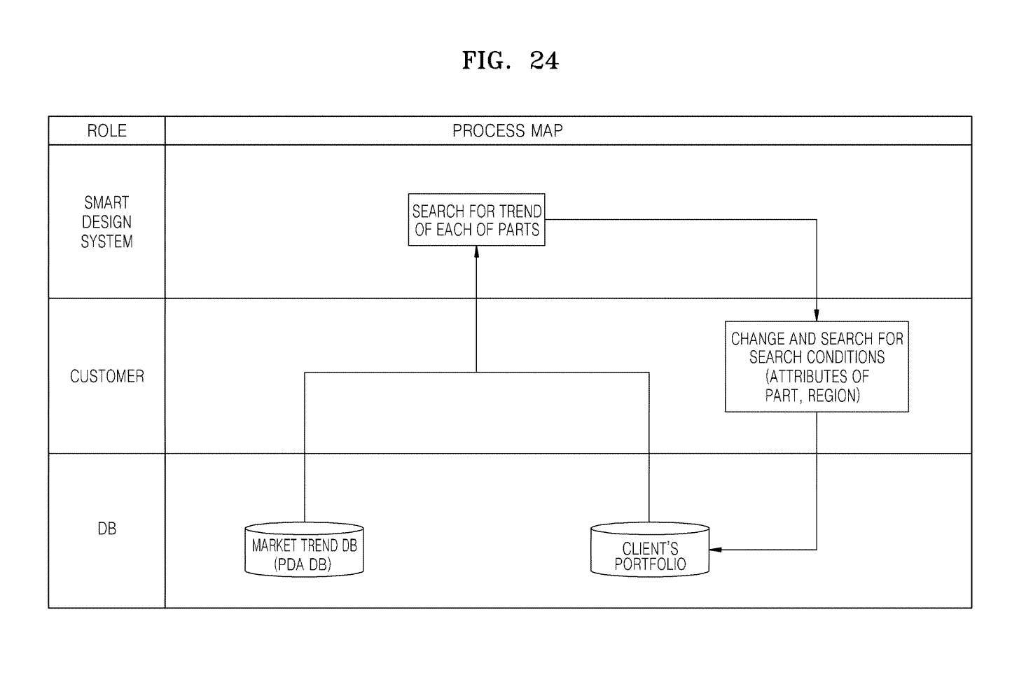

FIG. 24 is a conceptual diagram illustrating trend monitoring according to example embodiments. The trend monitoring will be described with reference to FIG. 24, in terms of a smart design system, a client, and a database.

To monitor a trend of products included in a designed application, various information related to the products is stored in a database. For example, in order to monitor the trend of the products under conditions such as product factors (or performances) and a region, information regarding the conditions may be also stored in the information. The database illustrated in FIG. 24 may be included in a smart design system according to example embodiments, and market trend information may be collected from the outside and stored in the form of a database. The market trend information may be changed and updated. The smart design system may output a result of performing trend monitoring by searching the information stored in the database for the trend of each of the products. When the client changes conditions such as product attributes or a region, the smart design system outputs a trend monitoring result changed by reflecting the change in the conditions. The client may check the trends of the products selected by the client, which are monitored according to the performance or region.

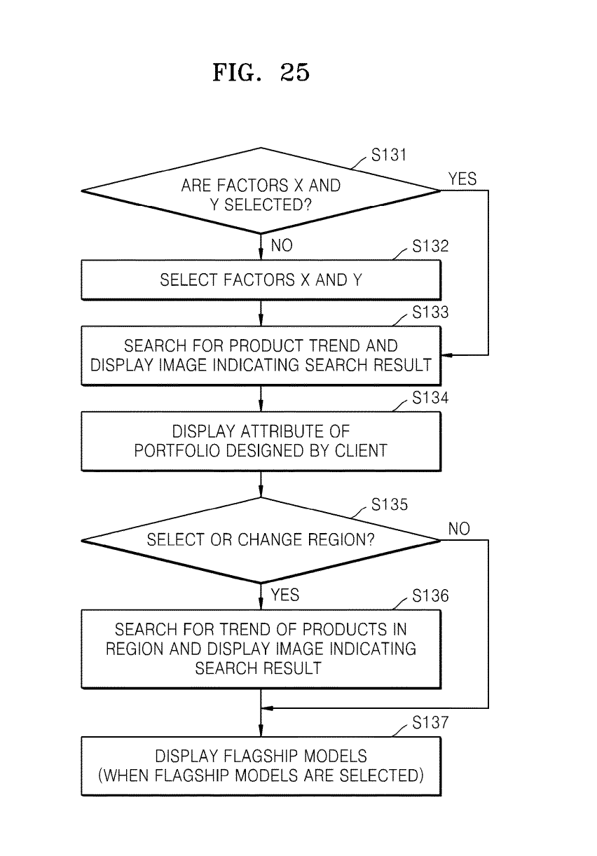

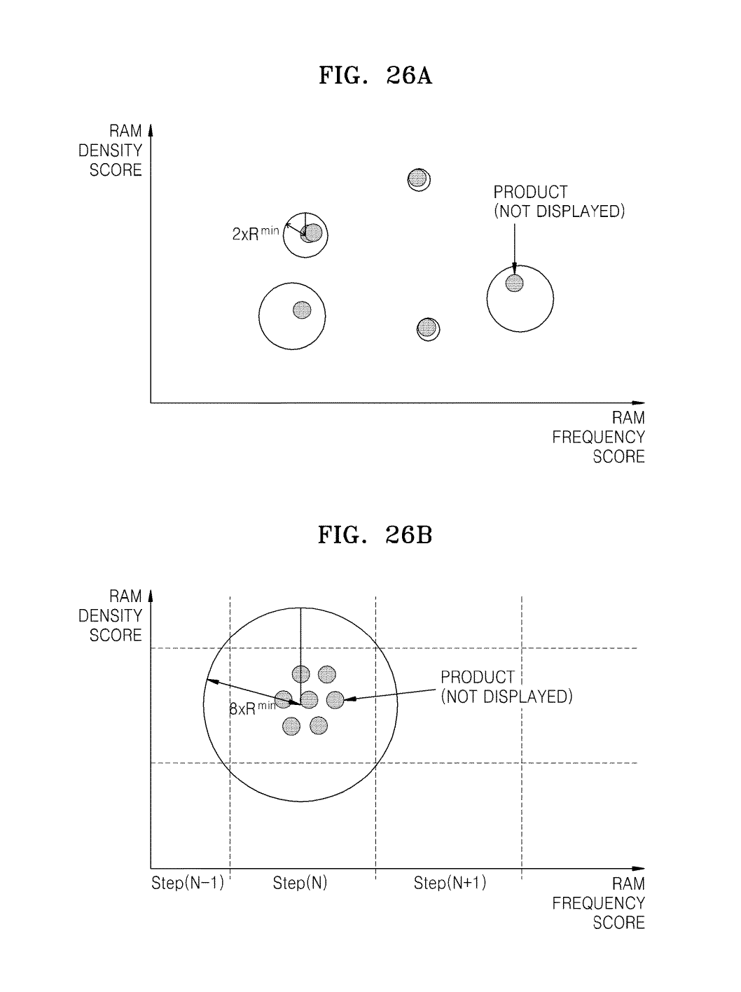

FIG. 25 is a flowchart illustrating the trend monitoring of FIG. 24 according to example embodiments. A market trend of products included in an application may be diagrammatized and output based on market information. For example, the market trend may be diagrammatized worldwide, and may further be diagrammatized by demographic information, such as in units of regions (e.g., Asia, America, Europe, etc.), age, gender, and/or other like demographics.

As illustrated in FIG. 25, first, whether factors x and y are selected may be determined, as shown in operation S131. As shown in operation S133, when the factors x and y are selected, product trends are searched for and an image indicating a search result is displayed. As shown in operation S132, when the factors x and y are not selected, a factor selection process is performed. Then, as shown in operation S133, product trends are searched for and an image indicating a search result is displayed. The factors x and y may be scores of attributes of the products. For example, an attribute score of a frequency of a RAM, an attribute score of a density of the RAM, an attribute score of the number of cores of a chipset, etc. may be selected.

As a result of searching for a market trend in units of regions with respect to the selected factors, a high group, a mid group, and a low group may be displayed according to the distribution of product groups, based on predetermined classification rules. Also, as shown in operation S134, an attribute of a portfolio designed by the client may be displayed together with the result of monitoring a trend.

As shown in operation S135, trend monitoring may be performed in units of regions, and whether a request to select or change a region is input from the client is thus determined. As shown in operation 5136, when the request to change a region is input from the client, the trend of the products in the region is searched for and an image indicating a search result is displayed. As illustrated in FIG. 25, flagship models may be further displayed according to the client's selection (operation S137). In this case, a predetermined number of flagship models (e.g., ten flagship models) having a high score may be displayed, and the manufacturing companies and model names of the flagship models may also be displayed.

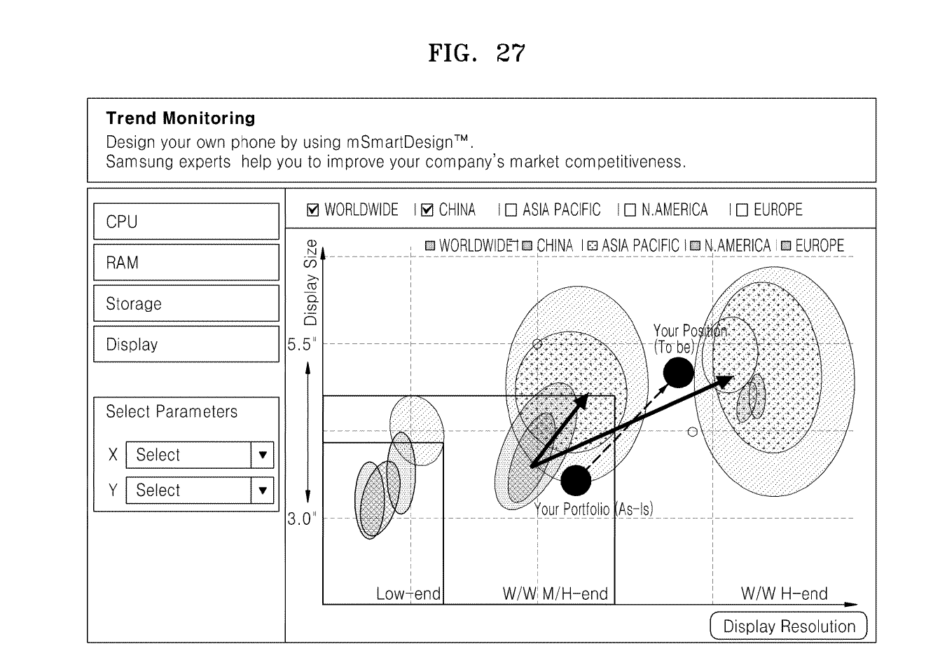

FIGS. 26A, 26B, and 27 illustrate screen images output as a result of searching for a trend monitoring result according to example embodiments. FIGS. 26A and 27B illustrate results of monitoring a trend using a score of a frequency of a RAM and a score of a density of the RAM.

A result of searching for a trend monitoring result may be displayed differently according to various classification rules. For example, as illustrated in FIG. 26A, factors x and y (e.g., a RAM frequency score, a RAM density score, etc.) may be defined, and a result of searching for a market trend may be displayed on a graph in the form of a circle. For example, a minimum radius size Rmin may be defined and the size of a circle may be set according to the number of products having the same or similar attributes in a market. A mark representing a product in the circle does not need to be output. In some embodiments, the size of a circle representing a market trend may be displayed as a multiple of the minimum radius size Rmin.

Similarly, a result of searching for a trend monitoring result may be displayed as illustrated in FIG. 26B. As described above, a minimum radius size Rmin may be defined. Also, at least one axis (e.g., X-axis and/or Y-axis) may be divided into several groups, and the size of a circle may be determined by the number of products belonging to one group. The groups may be classified as a high group, a mid group, and a low group, and the size of the circle may be a multiple of the minimum radium size Rmin (e.g., eight times than the minimum radium size Rmin).

FIG. 27 is a diagram illustrating a result of searching for a trend monitoring result according to example embodiments. For example, as illustrated in FIG. 27, a change in a trend of four products in various markets including worldwide markets may be displayed. The types of products may be displayed at a side of an image, and an image on which factors on the X-axis and the Y-axis are selected may be displayed to diagrammatize a trend of the products. A change in the trend of the products, caused by the client's selection, may be displayed. For example, when the X-axis and the Y-axis denote the resolution and size of a display, respectively, a market trend and a portfolio designed by a client are displayed together on a graph, and the location of an application designed by the client in the market trend may be checked.

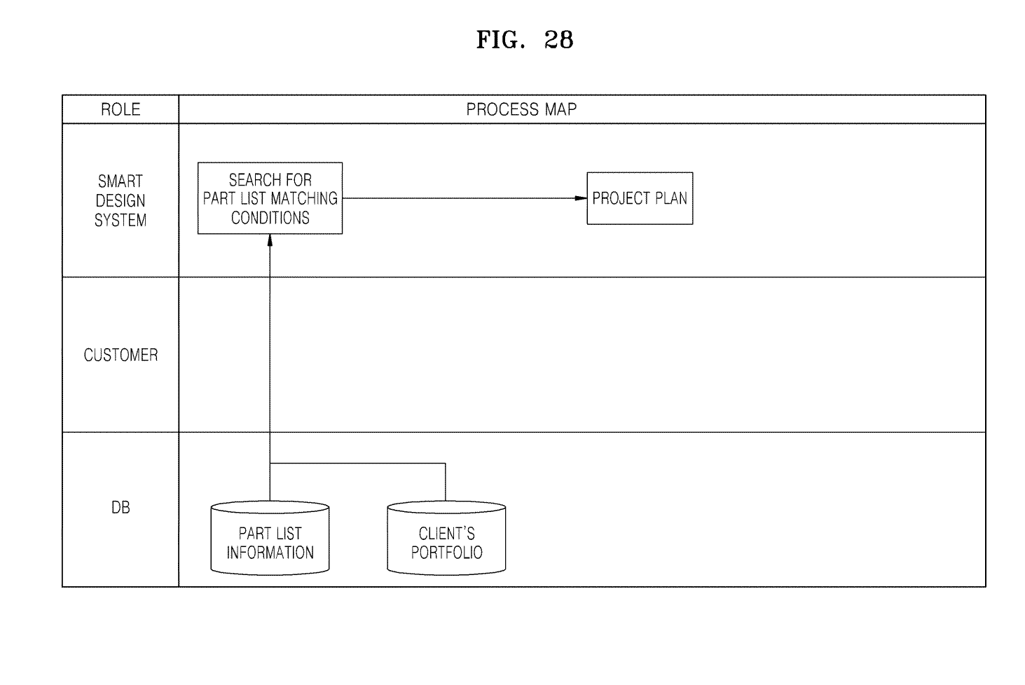

FIG. 28 is a conceptual diagram illustrating an operation of searching for detailed information regarding a product according to example embodiments. This operation will be described with reference to FIG. 28 below, in terms of a smart design system, a client, and a database.

Detailed information regarding a list of products is stored in a database. The smart design system searches product information corresponding to a portfolio of a client and the detailed information regarding the products for detailed information regarding a product, and outputs a search result. The client may finally select at least one product to purchase the at least one product. When the client selects to request a project plan to be driven, the smart design system drives the project plan in a manner that is the same as or similar to that described above in the previous embodiments. Thus, schedule information related to the product selected by the client may be provided to client.

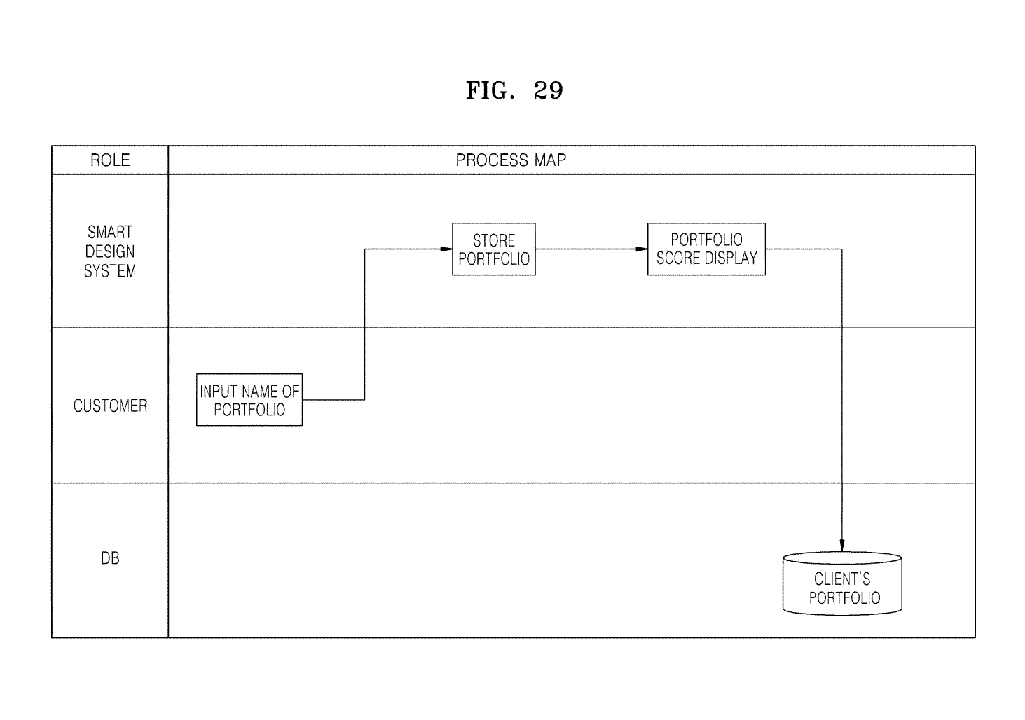

FIG. 29 is a conceptual diagram illustrating a portfolio storing operation according to example embodiments. This operation will be described with reference to FIG. 29 in terms of a smart design system, a client, and a database.

When a client requests a portfolio to be stored, for example, by inputting the name of the portfolio, the smart design system stores an application designed by the client as the portfolio of the client. Before the portfolio is stored, a portfolio score (or application score) may be output.

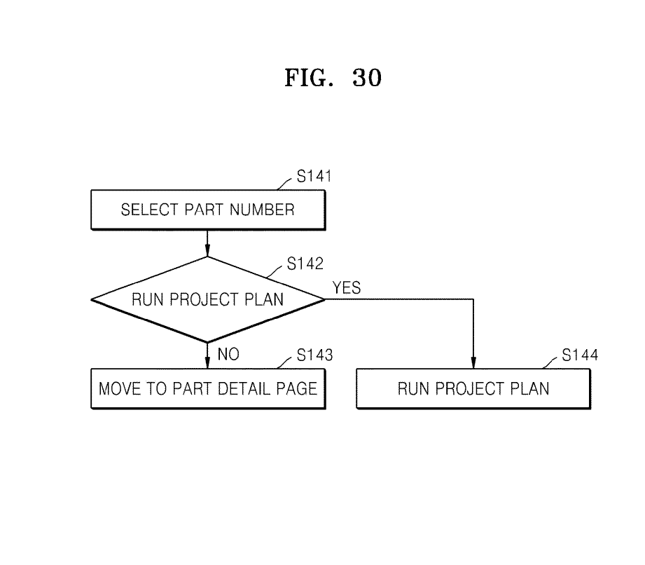

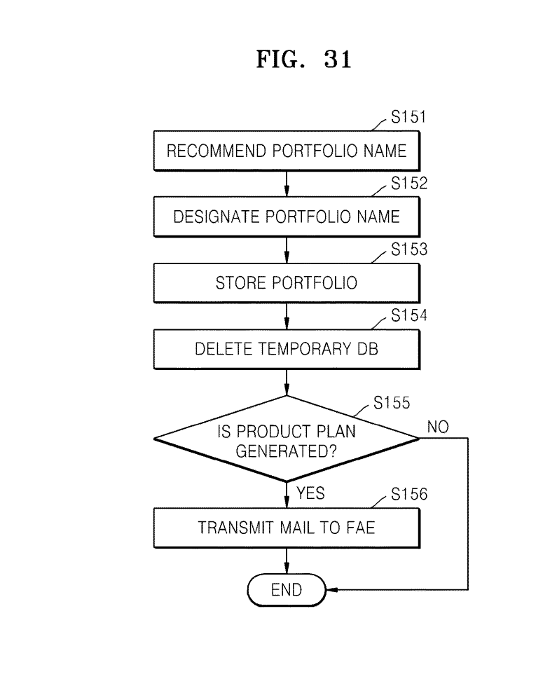

FIGS. 30 and 31 are flowcharts illustrating a method of searching for detailed information regarding a product and a method of driving a project plan according to embodiments. As illustrated in FIG. 30, a client may select the number of a product, the detailed information of which is to be checked, as shown in operation S141. Then, as shown in operation S142, whether a request to perform a product plan is received from the client may be determined. As shown in operation S143, if the request to perform the project plan is not received from the client, the client may be moved to a page displaying the detailed information regarding the product. As shown in operation S144, if the request to perform the project plan is received from the client, the project plan may be performed or otherwise developed.

In various embodiments, a list of products of a seller according to product standards may be displayed based on the number of the product selected by the client, and a link for the project plan and the page displaying the detailed information may be provided for the client to move to a desired page.

Also, as illustrated in FIG. 31, when an application designed by a client is requested to be stored, information regarding the design of the application planned by the client is stored as a portfolio of the client. For example, portfolio names may be recommended to store the portfolio, as shown in operation S151. As shown in operation S152, when the client designates the name of the portfolio, the design of the application planned by the client is then stored as the portfolio, as shown in operation S153. Since the portfolio is stored, as shown in operation S154, temporary data regarding the design of the application planned by the client may be deleted. Also, as shown in operation S155, whether a request to generate a product plan is received from the client may be determined. As shown in operation S156, when the request to generate a project plan is received, a mail may be transmitted to a manager configured to input information related to the project plan (e.g., field service engineer (FAE)), and the portfolio storing process may be completed. When the request to generate a project plan is not received, the portfolio storing process may be completed without performing any additional processes.

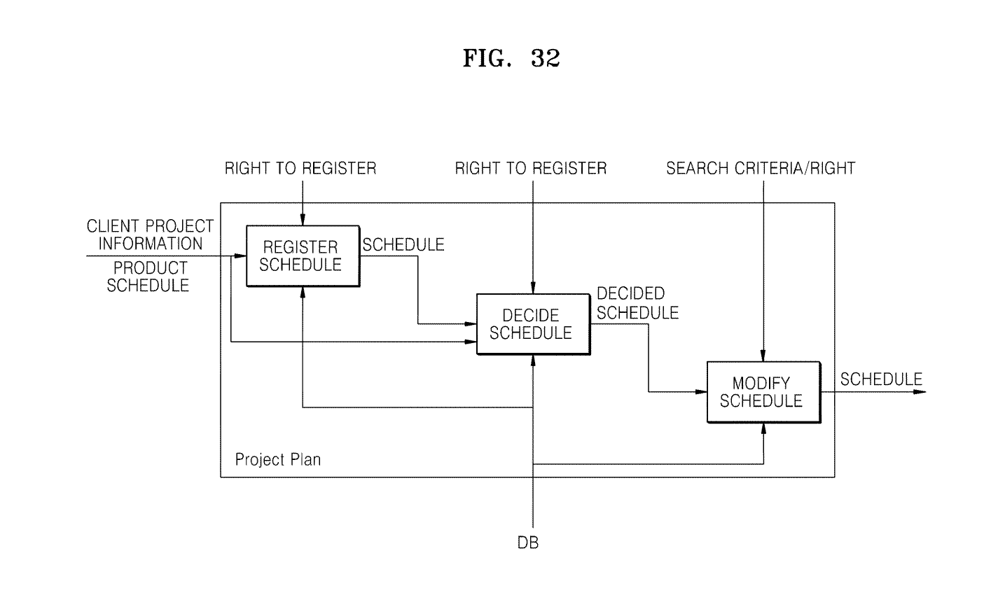

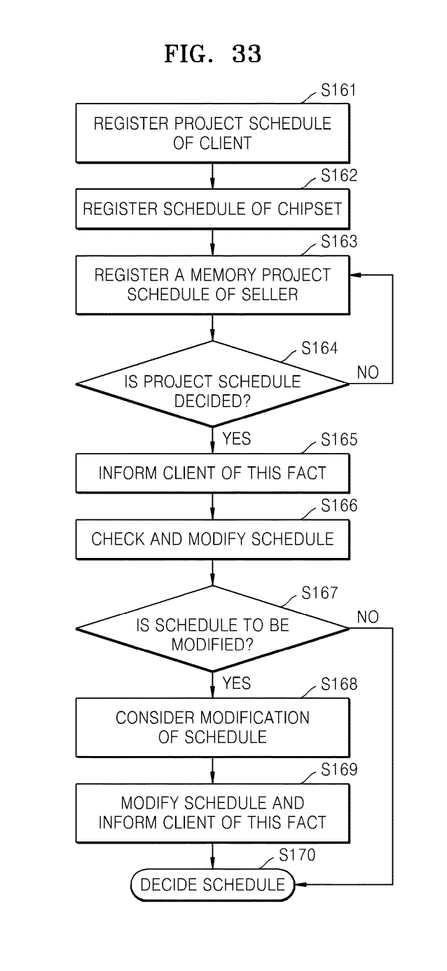

FIG. 32 illustrates functional blocks included in a project plan tool according to example embodiments. FIG. 33 is a detailed flowchart illustrating an operation of a project plan according to example embodiments.

The project plan tool may be included in a smart design system according to example embodiments. The project plan tool may include a first functional block for registering a schedule, a second functional block for deciding the schedule, and a third functional block for modifying the schedule as illustrated in FIG. 32. When project information of a client and product schedule information of a seller are input to the first functional block, the first functional block registers the schedule of a target product. Also, the first functional block may determine whether the client who requests the registration is assigned an appropriate right. To this end, registration right information may be provided to the first functional block.

The registered schedule of the target product may not be decided or may be decided. Thus, the second functional block may receive information indicating whether the schedule is decided or not, and may thus set as to whether the schedule is decoded or not. Information related to the decided schedule may be provided to the third functional block. The third functional block may determine whether the client has a right to search for the decided schedule, and provide a schedule modification function to the client. Also, the third functional block may receive information related to search conditions and display the schedule based on this information.

As illustrated in FIG. 33, a project schedule of the client is registered in relation to an operation of the project plan tool, as shown in operation S161. Also, as shown in operation S162, the schedule of a product (e.g., a chipset) included in a smart phone, a tablet, and/or other like device may be registered. The chipset may be a product of a company that is different from a seller that provides a smart design system service, and the schedule of the chipset may be thus registered by the client.

As shown in operation S163, a memory project schedule (e.g., seller memory product) may be as a product of the seller that provides the smart design system service. Also, as shown in operation S164, whether a project schedule is decided may be determined. If the project schedule is not decided, a process of registering the seller memory project schedule may be performed at a later time. If the project schedule is decided, as shown in operation S165, information indicating this fact may be sent to the client. Then, as shown in operation S166, the schedule may be checked or modified by the client.

Then, as shown in operation S167, whether a request to modify the schedule is input from the client may be determined. As shown in operation S170, when the request to modify the schedule is not input, the schedule is decided. As shown in operation S168, when the request to modify the schedule is input, modification of the schedule may be considered. As shown in operation S169, when the schedule may be modified, information related to the modification of the schedule may be sent to the client. Then, as shown in operation S170, the schedule may be decided.

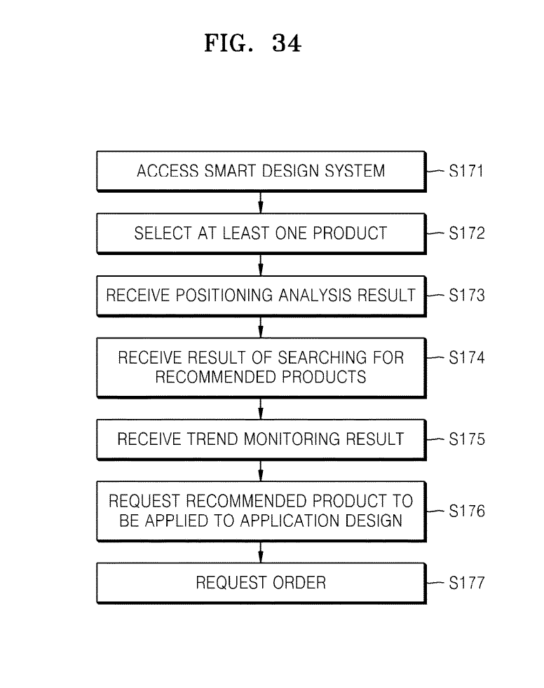

FIG. 34 is a flowchart illustrating a method of operating a client system according to example embodiments. The client system may be a client terminal that communicates with a smart design system via a network as described above. An operation of the smart design system is substantially the same as those in the previous embodiments and thus, will not be described in detail here.

As illustrated in FIG. 34, a client who desires to buy a product accesses the smart design system by using the client system via the network, as shown in operation S171. As shown in operation S172, the client selects an application to be designed by the client, and selects at least one product from among products included in the application to design the application.

Information regarding the at least one selected product may be provided to the smart design system, and the smart design system may design the application using the at least one selected product and provide the designed application to the client system. Also, the smart design system may provide a result of performing positioning analysis on the application, which is calculated using the at least one selected product, to the client system. Thus, as shown in operation S173, the client system receives a result of searching for at least one recommended product that is applicable to the application, based on the result of performing the positioning analysis. Thus, as shown in operation S174, the client system receives the positioning analysis result and the result of searching for the recommended products.

Then, as shown in operation S175, the smart design system provides a result of monitoring a trend in units of countries or regions to the client system as in the previous embodiments, and the client system receives the result of monitoring the trend. As shown in operation S176. The client may request a recommended product to be applied to the application design by selecting the recommended product from among recommended products, based on the positioning analysis result, the result of monitoring the trend, etc. Thereafter, as shown in operations S177, the client may transmit a request to order at least one product to the smart design system, based on the application to which the recommended product is applied.

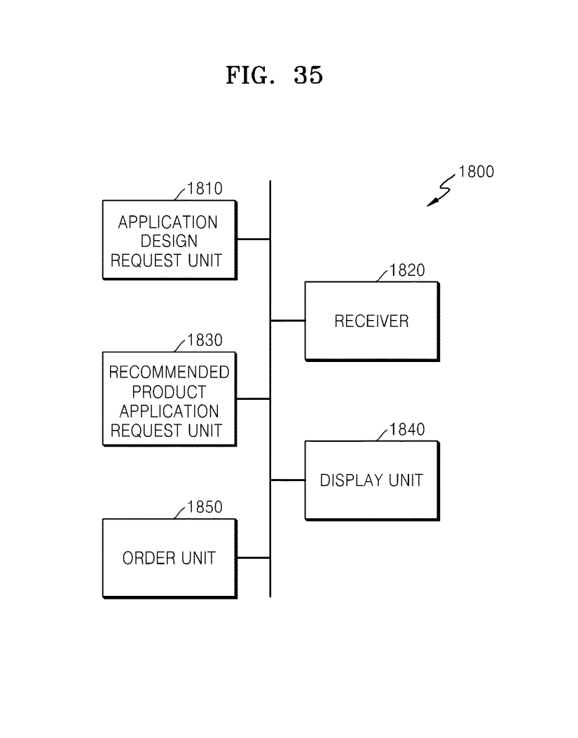

FIG. 35 is a block diagram of a client system 1800 according to example embodiments. As described above, an operation of a smart design system is substantially the same as in the previous embodiments and thus, will not be described in detail here.

The client system 1800 may include an application design request unit 1810, a receiver 1820, a recommended product application request unit 1830, and a display unit 1840. The application design request unit 1810 selects an application to be designed, and selects at least one product included in the application to design the application, thereby requesting the smart design system to design the application.

Also, the receiver 1820 receives various information related to the designed application from the smart design system. For example, the receiver 1820 may receive a result of designing the application in response to a request from the client, and receive a result of positioning analysis of the application from the smart design system. Also, the receiver 1820 may receive a result of searching for at least one recommended product applicable to the application according to a positioning analysis result. Also, the receiver 1820 may receive a result of monitoring a trend, which is performed in units of countries or regions. The received information may be displayed on the display unit 1840, and the positioning analysis result and the trend monitoring result may be diagrammatized and output.

The recommended product application request unit 1830 may request the client to select recommended products based on the result of searching for recommended products so that the recommended products may be applied to the application design. An order unit 1850 performs a request to order at least one product, based on various information provided through the above process. In response to the request, information related to the price and delivery date of the at least one product may be provided to the client system 1800.

While example embodiments have been particularly shown and described with reference to exemplary embodiments thereof, it will be understood that various changes in form and details may be made therein without departing from the spirit and scope of the following claims.

1. A method of operating a smart design server, the method comprising:
selecting, by the smart design server, at least one product of a plurality of products by searching a database storing information related to the plurality of products;
designing, by the smart design server, an application that includes the selected at least one product, the designing being used to produce the application;
providing, by the smart design server, at least one recommended product of the plurality of products, the recommended product being applicable to the application; and
providing, by the smart design server, a market trend analysis, the market trend analysis being generated by searching for information related to a market trend of at least one of the plurality of products applicable to the application.

2. The method of claim 1, further comprising:
storing the designed application as a portfolio.

3. The method of claim 1, further comprising:
analyzing a position of the selected at least one product relative to the application; and
providing a result of the analyzing to a client terminal, the providing the result including diagrammatizing the result.

4. The method of claim 3, wherein the analyzing comprises:
performing an arithmetic operation using at least one of a score assigned to the at least one product and a weight assigned to the selected at least one product.

5. The method of claim 1, wherein the result of analyzing the market trend is diagrammatized.

6. The method of claim 1, further comprising:
providing a plurality of options for the designing such that the application is designed using at least one of the plurality of options, and
the plurality of options include at least one of,
a first option for performing the designing using a selected reference model from among a plurality of reference models,
a second option for performing the designing using a stored portfolio, and
a third option for performing the designing by generating another portfolio.

7. The method of claim 1, further comprising:
analyzing position of the application using the at least one selected product,
a product score and a product weight are assigned to each of the plurality of products, and a product attribute score and a product attribute weight are assigned to each of the plurality of products according to attributes of each of the plurality of products, and
the analyzing the position includes,
calculating the product score for the selected at least one product using the product attribute score and the product attribute weight; and
calculating an application score for the selected at least one product using the calculated product score and the product weight.

8. The method of claim 7, wherein a different product attribute score is assigned to each of the at least one attribute according to specifications of the at least one selected product, and
the calculating the product score includes,
multiplying the attributes of each of the plurality of products by the product attribute score and the product attribute weight; and
adding a result of the multiplying together.

9. The method of claim 8, wherein the calculating the application score comprises:
multiplying the product scores assigned to the plurality of products by product weights corresponding to the product scores; and
adding results of the multiplying together.

10. The method of claim 1, further comprising:
analyzing a position of the selected at least one product by searching for specifications of the selected at least one product; and
displaying a result of the analyzing the position and the market trend analysis, the displaying including diagrammatizing the analyzing the position and diagrammatizing the market trend analysis.

11. The method of claim 1, wherein the application comprises one of a smart phone and a tablet, the plurality of products comprise at least a plurality of a dynamic random access memories (DRAMs) and a plurality of storage units, and the method further comprises:
analyzing a position of the application using the selected at least one product,
the analyzing including calculating (i) a product score of a selected DRAM of the plurality of DRAMs according to an operating frequency of the selected DRAM and a capacity of the selected DRAM, and (ii) a product score of a selected storage unit of the plurality of storage units according to a type of the selected storage unit and capacity of the selected storage unit.

12. The method of claim 11, wherein the providing a result of searching comprises:
searching for another one of the plurality of DRAMs and another one of the plurality of storage units, the product score of the other one of the plurality of DRAMs being greater than the product score of the selected DRAM and the product score of the other one of the plurality of storage units being greater than the product score of the selected storage unit; and
displaying a result of the searching, the result including the other one of the plurality of DRAMs and the other one of the plurality of storage units.

13. The method of claim 11, wherein the plurality of products further comprise a plurality of chipsets and a plurality of displays, and
the position of the application is analyzed by performing an arithmetic operation on the product scores of each of the plurality of DRAMs, each of the plurality of storage units, each of the plurality chipsets, and each of the plurality of displays.

14. The method of claim 1, further comprising:
redesigning the application based on a selection of at least one recommended product.

15. The method of claim 1, wherein the information related to a market trend of the plurality of products is stored in a database, the database being associated with the smart design server.

16. The method of claim 1, further comprising:
receiving a request to run a project plan tool; and
providing the project plan tool in response to the request, the project plan tool providing schedule information of the selected at least one product.

17. The method of claim 1, wherein a plurality of architecture types are defined for the application, and
the designing is performed by selecting products to be applied to a selected architecture type from among the plurality of architecture types.

18. The method of claim 1, further comprising:
analyzing a position of the application using the selected at least one product;
diagrammatizing a result of the analyzing by generating a graph including an x-axis and a y-axis, the at least one recommended product is represented by a mark on the x-axis and the y-axis; and
selecting the at least one recommended product by receiving information obtained by dragging a vertex of the figure to the mark.

19. The method of claim 1, wherein market trend analysis includes information regarding at least one market trend in units, the units including at least one demographic.

20. The method of claim 1, further comprising:
providing price information and delivery date information of the selected at least one product.

21.-29. (canceled)

30. A method of operating a client terminal, the method comprising:
accessing, by the client terminal, a smart design service;
selecting, by the client terminal, at least one product of a plurality of products to be included in an application, the at least one product being used by the smart design service to design the application, the design being used to produce the application;
receiving, by the client terminal, at least one recommended product, the at least one recommended product being one of the plurality of products, the at least one recommended product being determined to be applicable to the application; and
receiving, by the client terminal, market trend information to be used for a market trend analysis of at least one other product of the plurality of products determined to be applicable to the application.

31. The method of claim 30, further comprising:
receiving a position analysis of the application, the position analysis being calculated based on the selected at least one product, and
the at least one recommended product is determined to be applicable to the application according to the position analysis.

32. The method of claim 31, wherein at least one of the position analysis and the market trend information is plotted on a graph.

33. The method of claim 30, further comprising:
providing order information including at least one product.

34. The method of claim 30, wherein the market trend information includes demographic information to be used for the market trend analysis.

35.-41. (canceled)

42. A method of diagrammatizing a position of a product for designing an application by a smart design server, the method comprising:
determining, by a processor of the smart design server, a position of at least one selected product from among a plurality of products, the position being relative to the application;
diagrammatizing, by the processor, the position of the selected one of a plurality of products; and
providing, by the processor, the diagrammatized position to be used for producing the application.

43. The method of claim 42, wherein each of the plurality of products includes at least one attribute.

44. The method of claim 43, further comprising:
determining a product weight of each of the plurality of products;
determining a product attribute score of the at least one attribute of each of the plurality of products; and
determining a product attribute weight of the at least one attribute of each of the plurality of products.

45. The method of claim 44, further comprising:
determining a product score and a product weight of the selected at least one product.

46. The method of claim 45, wherein determining the product score and the product weight of the selected at least one product comprises:
calculating a product score by performing an arithmetic operation on the selected at least one product using the product attribute score and the product attribute weight, and
calculating an application score by performing an arithmetic operation on the product score calculated for the selected at least one product and the product weight; and

47. The method of claim 45, wherein the providing further comprises:
outputting the diagrammatized position according to the calculated application score.

48. A method of monitoring a market trend of at least one of a plurality of products applicable to an application designed by a smart design system, the method comprising:
selecting, by a processor, at least one product to be monitored for a market trend, the selected at least one product being one of the plurality of products;
diagrammatizing, by the processor, the monitoring of the market trend of the selected at least one product; and
providing, by the processor, the diagrammatized market to be used for designing an application, the design being used for producing the application.

49. The method of claim 48, wherein each of the plurality of products includes at least one attribute, and the method further comprises:
selecting at least one factor from among a plurality of factors to be monitored for the market trend, the plurality of factors being associated with at least one attribute of the selected at least one product.

50. The method of claim 49, wherein the diagrammatizing further comprises:
graphing the monitoring of the market trend according to the selected at least one factor.

51. The method of claim 48, wherein the diagrammatizing further comprises:
graphing the monitoring of the market trend according to at least one selected demographic, the at least one selected demographic being one of a plurality of demographics.
